(19) United States
(12) Patent Application Publication
(10) Pub. No.: US 2026/0278310 A1
(43) Pub. Date: Sep. 17, 2026

(54) SYSTEM

(71) Applicant: SoftBank Group Corp., Tokyo (JP)

(72) Inventor: Shuntaro YOSHIZU, Tokyo (JP)

(73) Assignee: SoftBank Group Corp., Tokyo (JP)

(21) Appl. No.: 19/553,457

(22) Filed: Mar. 2, 2026

Related U.S. Application Data
(60) Provisional application No. 63/771,346, filed on Mar. 13, 2025.

(51) Int. Cl. G06F 40/58; G06F 40/263; G06F 40/279; G06F 40/30; G06F 40/51

(52) U.S. Cl. CPC G06F 40/58; G06F 40/263; G06F 40/279; G06F 40/30; G06F 40/51

(57) ABSTRACT

A system includes a processor that is configured to receive a message input by a user, translate the message into a specified language, and transmit the translated message to a recipient.

### CROSS-REFERENCE TO RELATED APPLICATION

This application claims the benefit of U.S. Provisional Application No. 63/771,346, filed on Mar. 13, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional translation systems used in communication environments generally require a user to perform multiple operations, such as manually copying text into a separate translation application, selecting a target language in advance, visually confirming the translation result, and then manually transmitting the translated content through a messaging tool. Such workflows increase the number of user interactions, introduce latency, and make real-time communication with speakers of different languages difficult, particularly in time-sensitive situations such as business meetings, customer support, or travel-related conversations. Additionally, many existing systems do not seamlessly integrate message input, translation, and message transmission into a single continuous process; instead, they isolate translation from the message sending function, thereby imposing cognitive and operational burdens on the user. There is also a need for a mechanism that can reliably perform real-time translation using cloud-based translation services, while allowing the user to easily select a target language, without requiring the user to review or confirm each translation result before the translated message is transmitted. Accordingly, there is a demand for a system capable of receiving user messages, translating the messages into a specified language, and transmitting the translated messages to recipients in a streamlined and automated manner, thereby enabling more efficient and fluent cross-lingual communication.

### SUMMARY

In order to solve the aforementioned problems, the present invention provides a system comprising a processor, wherein the processor is configured to receive a message input by a user, translate the message into a specified language, and transmit the translated message to a recipient. The processor is further configured to access a cloud-based translation service to perform the translation in real time, provide an interface through which the user selects a target language, and execute the translation based on the selected target language. By using the cloud-based translation service, the processor can utilize high-performance neural or other advanced translation models without requiring heavy computation on a local device, thereby achieving high translation accuracy and low latency. Additionally, the processor is configured to immediately transmit the translated message to the recipient and to transmit the translated message directly without providing the user with an option to confirm the translation result. This configuration enables the entire sequence from message input to translation and transmission to be executed as a unified process with minimal user interaction.

As a result, the system reduces operational complexity, shortens communication delay, and allows the user to conduct seamless real-time communication with recipients who use different languages.

The term “system” refers to an arrangement of one or more hardware and/or software components that cooperate to perform the message input, translation, and transmission functions described in the claims.

The term “processor” refers to any hardware device, or combination of hardware and software, capable of executing instructions, including but not limited to a central processing unit (CPU), microcontroller, digital signal processor (DSP), application specific integrated circuit (ASIC), field programmable gate array (FPGA), or a distributed computing environment implementing equivalent processing functionality.

The term “message” refers to any unit of user-generated content intended for communication, including but not limited to text, characters, symbols, or other data that can be represented in textual form for translation and transmission.

The term “user” refers to a human operator who interacts with the system by inputting messages, selecting a target language, and initiating transmission of translated messages.

The term “recipient” refers to an intended destination entity for a message, including but not limited to another user, a group of users, a client device, a server, or an application endpoint that receives the translated message.

The term “message input” refers to the operation of providing a message to the system, including but not limited to entering text via a keyboard, touch interface, handwriting input, voice input converted to text, or any other input modality that results in a textual message.

The term “specified language” refers to a language that is designated by the system or selected by the user as the language into which the original message is to be translated.

The term “target language” refers to the particular specified language selected for translation of the message, which may be chosen by the user through an interface or determined by the system according to preset conditions.

The term “translate” refers to the process of converting a message expressed in a source language into a semantically corresponding message expressed in a different language, using automated computational methods.

The term “cloud-based translation service” refers to a translation function provided by one or more remote servers accessible over a network, which performs automated language translation using models or algorithms that are executed in a cloud computing environment.

The term “real time” refers to processing that is performed with sufficiently low latency such that, from the perspective of the user, the translation and transmission of the message occur substantially without noticeable delay during an interactive communication session.

The term “interface” refers to any hardware or software mechanism that enables the user to interact with the system, including graphical user interfaces, command-line interfaces, touch screens, menus, buttons, or dialog boxes through which the user can select a target language or initiate operations.

The term “execute the translation” refers to causing the translation process to be performed by invoking a translation function or service, providing the original message and translation parameters, and obtaining the translated message as a result.

The term “immediately transmit” refers to initiating transmission of the translated message to the recipient without requiring an additional confirmation operation by the user after completion of the translation.

The term “directly transmit” refers to sending the translated message to the recipient automatically upon completion of the translation process, without presenting the translation result to the user for approval or modification prior to transmission.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

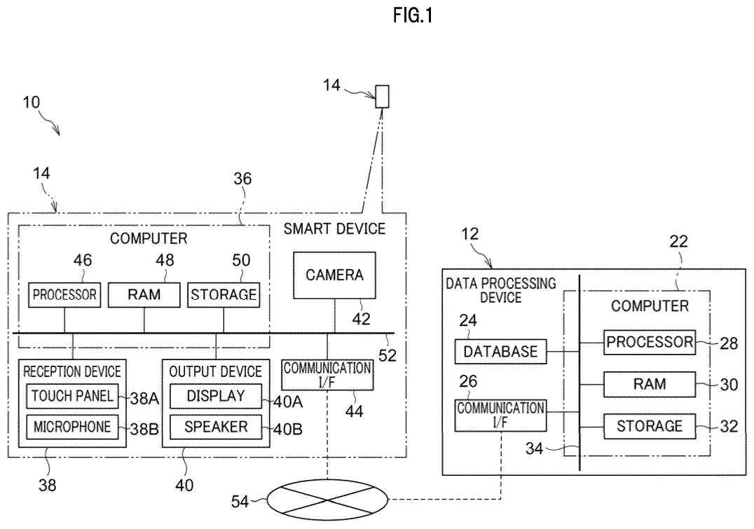

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

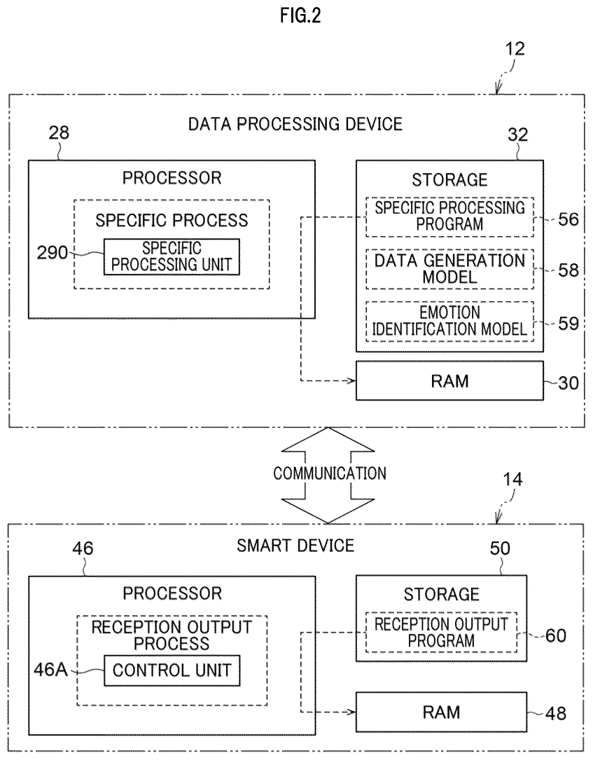

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional multilingual messaging systems typically rely on generic cloud translation services that operate as black boxes and are loosely coupled to end-user terminals. Such systems suffer from several technical deficiencies at the computing level.

First, conventional systems do not tightly integrate input-side preprocessing, such as noise reduction, error correction, and multimodal recognition (text, speech, handwriting), with the downstream translation pipeline. As a result, servers are forced to process low-quality or noisy input data, which increases recognition errors and degrades translation performance. This leads to inefficient utilization of processing resources, increased retransmissions, and additional latency in communication networks.

Second, many existing systems provide only static language selection interfaces and do not adapt to a user's language usage pattern at the terminal. Language selection lists are often long and unsorted, and the lack of frequency-based reordering causes unnecessary user interactions and delays. This results in increased processing overhead at the user terminal and slower overall end-to-end message throughput.

Third, conventional translation servers often treat each translation request independently and do not maintain or exploit consistent translation history across sessions. Without terminology-aware consistency processing, the server frequently generates inconsistent translations for the same phrases or domain-specific terms. This inconsistency forces users to manually correct or resend messages and causes redundant load on computing resources.

Fourth, even when user feedback regarding translation quality is collected, existing architectures rarely implement a systematic feedback loop that quantitatively analyzes such feedback at scale and directly links it to translation model configuration, terminology rules, or runtime parameters. The absence of an integrated analytics and adaptation mechanism prevents the system from improving its technical performance over time and leads to static or suboptimal model behavior.

Fifth, although generative AI models are widely available, conventional systems do not employ them in a structured, machine-driven manner to refine the translation pipeline itself. There is no automated mechanism to generate domain-specific prompt sentences based on observed error patterns and performance characteristics, send such prompts to a generative AI model, and automatically use the resulting recommendations to update translation model configurations or processing parameters. Consequently, model tuning remains manual, ad hoc, and resource-intensive, and the system cannot efficiently converge toward better technical performance.

Accordingly, there is a need for a technical solution that tightly couples input-side preprocessing at user terminals with server-side translation processing, that adaptively manages language selection at the terminal, that enforces translation consistency based on stored history, that systematically analyzes user feedback to derive performance characteristics, and that automatically interacts with a generative AI model using generated prompt sentences to update translation models and processing parameters. Such a solution should improve the functioning of the computer system itself, including reduced end-to-end latency, reduced error rates, more efficient use of network and processing resources, and improved stability and consistency of translation operations.

The specific processing by the specific processing unit 290 of the data processing device 12 in Example 1 is realized by the following means.

The present invention provides a server comprising a processor configured to receive, via a communication network, standardized message information and language identification information generated at a user terminal by applying at least one of error correction processing, noise reduction processing, character recognition processing, and speech recognition processing to user input, to execute at least one of language determination processing and translation processing based on a machine learning model on the standardized message information to generate translated message information, to perform terminology consistency processing on the translated message information based on translation history information stored in a translation history information storage unit so as to correct an expression of the translated message information, to transmit the translated message information as second transmission information to the user terminal or to another terminal, to receive evaluation information and improvement request information with respect to the translated message information from the user terminal, to store the evaluation information and the improvement request information in association with the translation history information, to perform aggregation processing and analysis processing on the stored information to generate characteristic information relating to translation performance, and to automatically generate, based on the characteristic information and the translation history information, a prompt sentence to be input to a generative AI model, transmit inquiry information including the prompt sentence to a generative AI model providing apparatus, and update at least one of translation model configuration information, terminology consistency processing conditions, and translation parameters in the translation processing based on response information acquired from the generative AI model. This enables an integrated computing architecture in which input-side preprocessing at the user terminal supplies higher-quality standardized data to the server, the server enforces historically consistent translations and adaptively tunes its translation pipeline by algorithmically analyzing user feedback and by automatically leveraging generative AI model recommendations via generated prompt sentences, thereby improving computer performance in terms of translation accuracy, latency, resource utilization, and stability of multilingual communication processing.

The term “user terminal” refers to an information processing device operated by a user, including but not limited to a portable terminal, a stationary terminal, or a general-purpose computing device, that executes an application for inputting message information, displaying translation results, and transmitting and receiving data via a communication network.

The term “character information” refers to digital data representing text symbols or alphanumeric characters input by a user through an input interface such as a keyboard, touch panel, or similar text input mechanism.

The term “voice information” refers to digital audio data representing spoken utterances of a user, acquired by an audio input interface such as a microphone and processed as a voice signal.

The term “handwriting information” refers to digital data representing a user's handwriting strokes, including coordinate data, timing information, and optional pressure information, acquired via a touch-sensitive surface, a pointing device, or a similar handwriting input interface.

The term “standardized message information” refers to message data that has been normalized by at least one of error correction processing, noise reduction processing, character recognition processing, and speech recognition processing so that the data is in a unified, machine-processable format suitable for translation processing.

The term “error correction processing” refers to processing that detects and corrects errors such as typographical errors, spelling mistakes, or recognition errors in character information or recognized text using correction rules, language models, or similar mechanisms.

The term “noise reduction processing” refers to processing that reduces or suppresses unwanted components, such as background noise or interference, from a voice signal to improve the signal-to-noise ratio and the accuracy of subsequent speech recognition processing.

The term “character recognition processing” refers to processing that converts handwriting information, image-based text, or similar non-typed character representations into digital text data using pattern recognition techniques or machine learning models.

The term “speech recognition processing” refers to processing that converts voice information into digital text data by analyzing acoustic features and applying language models or acoustic models implemented by a speech recognition engine.

The term “language identification information” refers to data indicating a translation target language or a source language, expressed for example as a language code or identifier, and used by a translation function to select an appropriate translation model or translation service.

The term “first transmission information” refers to data transmitted from the user terminal to the server via a communication network, including at least the standardized message information and the language identification information corresponding to a translation target language.

The term “second transmission information” refers to data transmitted from the server to the user terminal or another terminal via a communication network, including at least translated message information generated by translation processing.

The term “communication network” refers to any wired or wireless network infrastructure, including local networks and wide area networks, that enables data communication between the user terminal and the server or between terminals.

The term “server” refers to an information processing apparatus or a group of such apparatuses that receive data from the user terminal, execute translation processing and related processing, store and manage translation history and feedback information, and send processed data back to terminals via a communication network.

The term “language determination processing” refers to processing that determines or detects a language of input text or message information using a language identification algorithm or model.

The term “machine learning model” refers to a computational model obtained through a training process on data, including but not limited to neural network models, statistical models, or similar predictive models, used to perform translation processing, recognition processing, or related tasks.

The term “translation processing” refers to processing that converts message information expressed in a source language into message information expressed in a target language using a translation model, translation engine, or translation service based on a machine learning model.

The term “translated message information” refers to message data obtained as a result of translation processing, expressed in a target language corresponding to the language identification information.

The term “translation history information” refers to stored data representing past translation operations, including at least original message information, corresponding translated message information, source language, target language, and optionally associated metadata such as timestamp, user identifier, or context information.

The term “translation history information storage unit” refers to a storage function or storage resource, such as a database or memory, that stores and manages translation history information so that it can be referenced and used in subsequent processing.

The term “terminology consistency processing” refers to processing that adjusts or corrects specific terms or phrase segments in translated message information based on translation history information or terminology rules so as to maintain consistency of wording across multiple translations.

The term “setting information” refers to data that defines operational preferences or parameters of the system, including at least a translation target language selected or changed by a user and information related to language selection behavior or display preferences at the user terminal.

The term “candidate languages” refers to a set of languages presented to the user at the user terminal as possible choices for translation target languages or source languages in a language selection interface.

The term “use frequency” refers to information indicating how often a particular language has been selected or used as a translation target language or otherwise, and is used to adjust the display order of candidate languages.

The term “evaluation information” refers to data indicating a user's evaluation of translated message information, including but not limited to quantitative ratings, qualitative comments, or other feedback data provided via a user interface.

The term “improvement request information” refers to data that expresses a user's request, suggestion, or indication of desired changes regarding translation results or system behavior, used to guide improvements to translation processing or related functions.

The term “aggregation processing” refers to processing that collects and summarizes multiple pieces of evaluation information and improvement request information, for example by computing statistical values or aggregating occurrences by category.

The term “analysis processing” refers to processing that analyzes aggregated data, such as evaluation information and improvement request information, in order to extract patterns, tendencies, error types, or other characteristics related to translation performance.

The term “characteristic information relating to translation performance” refers to information derived from aggregation processing and analysis processing that describes quantitative or qualitative aspects of translation behavior, such as accuracy metrics, error patterns, domain-specific weaknesses, or language-pair-specific characteristics.

The term “generative AI model” refers to a computational model trained using machine learning techniques, such as a large language model or a generative model, that generates text or other content in response to input data, including prompt sentences and context information.

The term “prompt sentence” refers to text data formulated to be provided as input to a generative AI model, describing a task, problem, context, or requirement so as to elicit a useful response for improving or configuring the system.

The term “generative AI model providing apparatus” refers to an external system, service, or device that executes a generative AI model and provides response information in reply to inquiry information including a prompt sentence.

The term “inquiry information” refers to data transmitted to the generative AI model providing apparatus, including at least a prompt sentence and optionally accompanying context information, performance data, or example translations.

The term “response information” refers to data received from the generative AI model providing apparatus as a response to inquiry information, including recommendations, configuration suggestions, or other guidance for modifying translation-related processing.

The term “translation model configuration information” refers to information that defines operational settings of a translation model, including but not limited to model selection, parameter settings, architecture options, or model routing rules used in translation processing.

The term “terminology consistency processing conditions” refers to parameters or rules that govern how terminology consistency processing is performed, including term priority rules, domain-specific terminology constraints, and conditions for replacing translation segments.

The term “translation parameters” refers to runtime parameters or control values used in translation processing, such as decoding parameters, confidence thresholds, or domain selection indicators that influence how a translation model generates translated message information.

The term “voice acquisition function” refers to a hardware or software function at the user terminal that acquires a voice signal from a user via an audio input interface and provides the signal for subsequent processing, including noise reduction processing and speech recognition processing.

The term “handwriting trajectory information” refers to data representing the path of handwriting input, including coordinates, timing, and optionally pressure or orientation information, which is used as input to character recognition processing.

The term “first transmission function” refers to a function executed at the user terminal that constructs and sends first transmission information including standardized message information and language identification information to the server via a communication network.

The term “transmission result information” refers to data indicating a result of sending second transmission information, including statuses such as success, failure, or delivery confirmation, which is transmitted from the server to the user terminal to update a display state.

The term “display state” refers to a visual or other perceptible representation on the user terminal indicating the current status of messages, including sent messages, delivered messages, or translation results, and associated indicators such as icons or textual notifications.

In one embodiment, a system for multilingual message translation includes at least one server and one or more terminals interconnected via a communication network. The server and each terminal include a processor and a memory storing instructions which, when executed by the processor, cause the server or terminal to perform the functions described below. The system is implemented using general-purpose computing hardware, such as a mobile computing device, a desktop computing device, or a rack-mounted computing device, and software components including an operating system, a communication stack, and application programs.

A terminal provides a user interface for message input, language selection, display of translated messages, and feedback submission. The terminal uses hardware such as a touch-sensitive display, a microphone, a speaker, and optionally a stylus input device. The terminal executes an application realized, for example, as a native mobile application implemented using a platform-specific framework or as a desktop application. The terminal stores configuration data and local message records in a non-transitory storage medium such as flash memory or a magnetic disk.

A terminal acquires character information by presenting a text input field on the display and receiving key events from a virtual keyboard or a physical keyboard. The terminal optionally uses an integrated spell-check service provided by the operating system to perform error correction processing on the character information. The spell-check service uses a dictionary and a statistical language model to identify unlikely character sequences and replace them with candidate words, thereby generating standardized message information with reduced input errors before transmission to the server.

A terminal acquires voice information by activating the microphone and sampling audio at a predetermined sampling rate. The terminal performs noise reduction processing on the sampled audio using an audio processing library that implements, for example, spectral subtraction or a recurrent neural network-based denoising algorithm. The terminal thus attenuates stationary and non-stationary noise components from the audio signal. By performing this processing at the terminal, the system supplies a higher signal-to-noise ratio input to subsequent speech recognition processing, which improves recognition accuracy and reduces the need for retransmission due to recognition errors.

A terminal performs speech recognition processing on the noise-reduced audio using a speech recognition engine that implements an acoustic model and a language model. The acoustic model is realized as a neural network, for example a time-delay neural network, a recurrent neural network, or a transformer-based acoustic model, trained on large-scale speech corpora.

The language model is realized, for example, as an n-gram model or a transformer language model. The speech recognition engine computes acoustic feature vectors such as Mel-frequency cepstral coefficients or log-mel filterbank energies, feeds them into the acoustic model, and computes posterior probabilities over phonetic or subword units. The language model combines these probabilities with linguistic constraints to output the most likely character sequence. The terminal receives this character sequence and treats it as standardized message information.

A terminal acquires handwriting information when the user writes on the touch-sensitive display using a stylus or a finger. The terminal records a sequence of coordinate points, timestamps, and optionally pressure or tilt values as handwriting trajectory information. The terminal applies character recognition processing by passing the trajectory information to a handwriting recognition engine that implements a sequence model, such as a recurrent neural network or a convolutional-recurrent network. The handwriting recognition engine normalizes the trajectories, extracts stroke features, and decodes them into character sequences. The terminal converts the handwriting information into standardized message information in text form.

A terminal maintains language identification information as part of setting information. The terminal provides a language selection interface displaying a list of candidate languages in a graphical control element. The terminal stores, for each language, a use frequency count in local storage. When the user selects a language as a translation target language, the terminal increments the corresponding frequency count and reorders the display of candidate languages such that more frequently used languages appear in a higher position. This reordering reduces the number of user interactions required for language selection and thereby reduces processing load and latency caused by repeated language selection operations.

A terminal constructs first transmission information by encapsulating the standardized message information and the language identification information into a structured data object in the memory. The terminal further adds metadata such as a user identifier and a timestamp. The terminal then transmits the first transmission information to the server using a network communication library, which performs encoding into a message format and passes the message to a transport protocol stack and underlying physical communication hardware. By performing preprocessing and structuring at the terminal, the system reduces the computation required at the server for input cleaning and format normalization and thereby improves overall throughput.

A server receives first transmission information from one or more terminals via the communication network. The server executes a communication process that terminates a secure channel, parses message headers, and extracts a payload containing the standardized message information and the language identification information. The server may perform language determination processing by applying a language identification model when the source language is not explicitly specified. The language identification model may be a classifier trained using a supervised learning algorithm on character n-gram features or subword embeddings. The classifier outputs the most probable language class for the input text, and the server associates this language class with the message.

A server performs translation processing using a machine learning model. In one embodiment, the machine learning model is a neural machine translation model realized as an encoder-decoder architecture with an attention mechanism or a transformer architecture. The encoder converts tokenized source language sequences into contextualized vector representations using multiple layers of self-attention and feed-forward networks. The decoder generates target language tokens by attending to the encoder representations and previously generated tokens. The model parameters are obtained by training on parallel text corpora using a backpropagation algorithm with an objective function such as cross-entropy loss between predicted token distributions and reference translations. During inference, the server performs beam search decoding or similar decoding strategy with specified decoding parameters such as beam width, length normalization, or coverage penalties.

A server optionally uses an internal routing mechanism to select among multiple translation models based on language pair, domain, or context. The server refers to configuration information that maps language pairs and context categories to particular translation models or model versions. The server thereby controls which model to use for a given request, enabling specialized models for business domains, technical domains, or informal conversation.

A server stores translation history information in a structured data storage such as a relational database or a key-value store. For each translation operation, the server records original message information, translated message information, source language, target language, user identifier, timestamp, and optional context information. The server indexes the translation history information by text segments and terms to support fast lookup. The server performs terminology consistency processing by querying the translation history storage for previous translations of the same or related source segments. The server uses explicit terminology rules stored in another data structure, such as a terminology table storing source term-target term pairs and their domains. The server identifies occurrences of terms in the translated message information, compares them with preferred target terms from the terminology table and translation history, and replaces or annotates inconsistent terms. This processing reduces term variation across translations and improves the consistency of the output as perceived by machines and users.

A server transmits the translated message information as second transmission information to the original terminal or another terminal. The server constructs a message data structure containing the translated message information and metadata and passes it to a messaging subsystem. The messaging subsystem maintains session state and device identifiers for terminals. The server pushes the second transmission information to the target terminal via a communication protocol such as a persistent connection or a push notification mechanism. The server also transmits transmission result information back to the sender terminal to indicate success or failure of delivery. By integrating translation and messaging functions at the server, the system reduces the number of distinct network round trips and thereby reduces end-to-end latency.

A terminal receives second transmission information from the server and updates the display state to show the translated message information and the delivery status. The terminal stores local copies of sent and received messages in a local storage structure for later retrieval and display. The terminal may display the translated message information without requiring the user to confirm the translation result. This design enables a real-time communication behavior suitable for synchronous interactions such as conferences or live chats.

A terminal provides an interface through which a user can supply evaluation information and improvement request information about the translated message information. The terminal displays a control for rating and a field for comments. The terminal structures this feedback into a feedback data object associating the original message, the translated message, the language pair, and the user-provided evaluation. The terminal transmits the feedback data object to the server via the communication network.

A server receives evaluation information and improvement request information and associates this feedback with corresponding translation history information using identifiers. The server stores the feedback in a feedback storage structure. The server periodically performs aggregation processing by computing statistics such as average ratings per language pair, per domain category, or per term. The server performs analysis processing on aggregated feedback using numerical analysis libraries and machine learning algorithms. For example, the server may perform clustering of error cases using feature vectors that represent language pair, domain, length, and error type inferred from comments. The server may also compute performance metrics such as error rates for specific constructions (e.g., time expressions, named entities) based on pattern matching rules applied to the original and translated messages.

A server generates characteristic information relating to translation performance by combining aggregated statistics, identified error patterns, and model performance metrics such as latency and memory consumption. This characteristic information is stored in a dedicated data structure and used for subsequent adaptation of the translation pipeline.

A server automatically generates prompt sentences to be provided as input to a generative AI model. The server constructs the prompt sentences based on characteristic information and translation history information. For example, the server may compose prompt sentences such as:

“Analyze common error patterns in translations of time expressions from source language A to target language B and propose modifications to the translation model and terminology rules.”

“Design an improved decoding strategy for a neural machine translation model to handle domain-specific business terms consistently in target language C.”

“Given user feedback indicating that politeness levels are incorrectly translated in customer support messages, propose adjustments to model configuration and post-processing rules.” These prompt sentences are assembled programmatically by the server from templates and variable portions derived from stored data. The server constructs inquiry information containing the prompt sentence and optionally attaches representative examples from the translation history and feedback data, suitably anonymized and formatted.

A server transmits the inquiry information to a generative AI model providing apparatus over the communication network. The generative AI model providing apparatus executes a generative AI model, for example a large language model based on a transformer architecture trained on diverse text data. The generative AI model receives the prompt sentence and produces response information containing proposed modifications to model configuration, terminology rules, or processing flows. The server receives the response information and interprets it according to predetermined parsing rules. The server extracts actionable configuration changes such as revised translation model selection rules, updated terminology entries, or recommendations on decoding parameters.

A server updates translation model configuration information, terminology consistency processing conditions, and translation parameters based on the response information. The server may update entries in configuration data structures, modify thresholds and weights used in routing logic, or change parameters such as beam width or maximum sequence length.

In another embodiment, the server uses the response information to define new training or fine-tuning tasks for translation models. For example, the server may schedule a training job that fine-tunes an existing translation model on subsets of translation history where feedback indicates low performance, using a loss function such as cross-entropy combined with regularization terms to avoid overfitting. The server may apply data augmentation techniques such as back-translation or synthetic phrase generation to increase training data diversity. Model weights are updated using gradient-based optimization algorithms such as stochastic gradient descent or variants thereof. Once a new model or configuration is validated, the server deploys it and updates the routing configuration to direct relevant traffic to the improved model.

A server thereby implements a feedback-driven and AI-assisted adaptation loop that operates at the system level. This loop is not limited to automating human decision-making but reconfigures and improves internal computing components and control flows. By leveraging structured feedback and characteristic information, and by using generative AI model outputs to modify low-level parameters and rules, the system reduces error rates, avoids repeated incorrect translations, and decreases computational waste caused by reprocessing and manual correction. The system also achieves lower latency by tuning decoding parameters and parallelization strategies in response to empirical performance data.

A terminal and a server together realize multiple alternative embodiments. In one embodiment, the terminal performs only limited preprocessing, and the server performs more extensive noise reduction and recognition processing. In another embodiment, the terminal performs most preprocessing steps, including noise reduction, speech recognition, and handwriting recognition, and the server receives fully standardized text. In yet another embodiment, the system employs multiple translation models with different architectures, such as recurrent encoder-decoder networks and transformer networks, and the server selects an appropriate architecture based on message features such as length, domain, or detected complexity.

A server may also implement rule-based post-processing in combination with neural translation. For instance, the server may define pattern-based rules for punctuation normalization, number formatting, and date/time conversion. These rules operate on token sequences output from the translation model and transform them into canonical forms suited for specific locales. Such rule-based modules operate according to deterministic algorithms that are independent of user behavior and improve the readability and correctness of the output.

A terminal and a server thereby cooperate to realize a system that improves computer technology itself. The system increases recognition and translation accuracy by performing targeted preprocessing, reduces communication and computation load by avoiding redundant processing, improves consistency of outputs by using translation history and terminology rules, and enables efficient, automated adaptation of internal models and parameters using structured interaction with a generative AI model via prompt sentences. Through these mechanisms, the system goes beyond simple automation of human translation tasks and instead achieves technical improvements in the operation of computing devices and communication infrastructures.

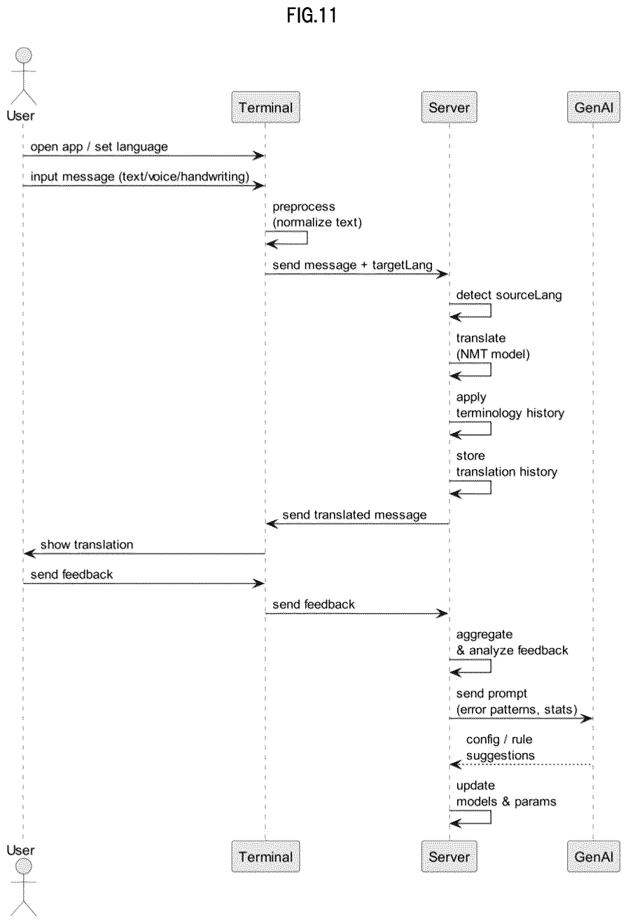

The following describes the processing flow using FIG. 11.

### Step 1:

The user activates the application on the terminal and opens the messaging screen.

The terminal, as input, reads stored configuration data from local storage, including previously selected translation target language codes, language usage frequencies, and user interface preferences.

The terminal performs data loading and parsing operations on this configuration data, and as output, generates in-memory structures representing the current target language, an ordered list of candidate languages, and initial UI state parameters.

The terminal then renders the messaging screen, showing a message input field, a “Send in [target language]” button labeled with the current target language, and a settings control for language selection.

### Step 2:

The user selects or confirms the translation target language on the terminal.

The terminal, as input, receives a user interaction event when the user taps the language settings control or long-presses the “Send in [target language]” button.

The terminal reads the current language list and associated use frequency counters from local storage and displays the candidate languages in a list component.

The user taps a desired language in the list.

The terminal performs an update operation on the configuration data by setting the selected language code as the new translation target and incrementing the corresponding use frequency counter.

The terminal, as output, writes the updated configuration to local storage and regenerates the ordered language list by executing a sort operation based on the updated frequencies.

The terminal updates the UI so that the “Send in [target language]” button displays the newly chosen language and the candidate language list appears in an order that reflects actual usage patterns.

### Step 3:

The user inputs a message as character information on the terminal.

The terminal, as input, receives a stream of key events from a virtual keyboard or physical keyboard while the user types into the message input field.

The terminal concatenates these key events into a character sequence and calls an error correction module that compares substrings against a dictionary and a statistical language model.

The terminal performs tokenization, candidate generation, and candidate scoring operations, then replaces low-probability character sequences with higher-probability candidates, thereby correcting typographical errors.

The terminal, as output, produces standardized message information in the form of a corrected text string and displays this string in the message input field for the user to review.

### Step 4:

The user inputs a message as voice information on the terminal.

The terminal, as input, captures an audio signal from the microphone when the user presses a microphone button and speaks.

The terminal segments the continuous audio into frames, applies a noise reduction algorithm such as spectral subtraction or neural denoising to each frame, and computes acoustic feature vectors such as Mel-frequency cepstral coefficients.

The terminal sends these feature vectors to a speech recognition engine, which applies an acoustic model and a language model to compute the most likely sequence of text tokens.

The terminal, as output, receives a recognized text string representing the spoken content, treats it as standardized message information, and inserts this string into the message input field, where the user can optionally edit the content.

### Step 5:

The user inputs a message as handwriting information on the terminal.

The terminal, as input, collects handwriting trajectory information consisting of coordinate points, time stamps, and optional pressure values whenever the user writes in a handwriting area.

The terminal normalizes the trajectories, segments strokes into candidate characters, and calls a handwriting recognition engine that applies a neural sequence model to map stroke patterns to text character sequences.

The terminal performs decoding of the model outputs using a beam search or similar algorithm to determine the most probable character sequence.

The terminal, as output, generates standardized message information in the form of recognized text and places this text into the message input field, making the content available for further processing.

### Step 6:

The user confirms the message and initiates translation at the terminal.

The terminal, as input, takes the standardized message information in the message input field and the current translation target language code from its configuration.

The terminal validates that the message is non-empty and that a target language code is present.

The terminal constructs a first transmission information object that includes the standardized message information, the translation target language code, a user identifier, a timestamp, and optional context attributes such as domain or conversation ID.

The terminal, as output, encodes this object into a network message and sends it via a communication library to the server over a communication network.

### Step 7:

The server receives and parses the first transmission information.

The server, as input, accepts an incoming network message containing the first transmission information from the terminal.

The server performs decryption and integrity checks at the transport layer, then extracts the payload and parses the structured data to obtain the standardized message information, the language identification information, and associated metadata.

The server validates the fields, ensuring that the target language code is supported and the text length falls within acceptable limits.

The server, as output, generates an internal request record in memory that contains all parsed fields and a unique identifier for tracking subsequent processing.

### Step 8:

The server determines the source language when necessary.

The server, as input, inspects the internal request record and checks whether a source language code is explicitly provided or is set to automatic detection.

When automatic detection is required, the server extracts character n-gram features or subword units from the standardized message information and feeds them into a language identification model.

The language identification model applies learned weights to these features and computes class probabilities over possible languages.

The server selects the language with the highest probability as the detected source language.

The server, as output, updates the internal request record to include this detected source language code, which is used in subsequent translation processing and logging.

### Step 9:

The server performs translation processing using a neural translation model.

The server, as input, takes the standardized message information, the detected or known source language code, and the translation target language code from the internal request record.

The server tokenizes the input text into subword units, maps these units to embedding vectors, and feeds the sequence into an encoder-decoder neural network such as a transformer-based machine translation model.

The encoder computes contextualized representations of the source sequence, and the decoder iteratively generates target tokens using attention mechanisms over the encoder outputs and previously generated tokens.

The server applies a decoding strategy such as beam search with configured parameters (e.g., beam size, length penalty) and computes probability scores for candidate translations.

The server selects the best-scoring sequence of target tokens, detokenizes them into text, and forms an initial translated message information string.

The server, as output, produces this initial translated message information and attaches it to the internal request record for further processing.

### Step 10:

The server applies terminology consistency processing based on translation history.

The server, as input, receives the initial translated message information and accesses translation history information stored in a database.

The server performs lookups using key structures such as hashes of source segments, term identifiers, or phrase pairs to retrieve previous translations and terminology entries.

The server identifies terms or phrases in the initial translated message information by performing pattern matching or token-level alignment between the source and target segments.

The server compares the identified target terms to preferred target terms stored in a terminology table or derived from frequently used historical translations.

The server replaces inconsistent target terms with the preferred terms or annotates them according to predetermined rules.

The server, as output, generates a corrected translated message information string in which terminology is consistent with stored translation history and domain-specific rules, and updates the internal request record with this corrected version.

### Step 11:

The server stores translation history including feedback linkage capability.

The server, as input, takes the original standardized message information, the corrected translated message information, the source and target language codes, the user identifier, and context information from the internal request record.

The server constructs a translation history entry containing these fields and a unique translation identifier and writes this entry into a translation history storage structure.

The server creates database indices on key fields such as source text, language pair, or domain to enable efficient retrieval in future processing.

The server, as output, returns the unique translation identifier and references to the stored entry so that feedback received later can be linked directly to this translation.

### Step 12:

The server sends the translated message as second transmission information.

The server, as input, takes the corrected translated message information and relevant metadata from the internal request record.

The server constructs second transmission information by packaging the translated message, the translation identifier, the source user identifier, and the recipient identifier(s).

The server passes this package to a messaging subsystem that determines the destination terminal(s) and selects appropriate delivery channels, such as persistent connections or push notifications.

The server, as output, transmits the second transmission information to the target terminal(s) and generates transmission result information indicating success or failure, which the server sends back to the sending terminal to update its display status.

### Step 13:

The terminal receives the translated message and updates the display.

The terminal, as input, receives second transmission information from the server, containing the translated message information and metadata.

The terminal parses the message, extracts the translated text, and inserts a new message element into its user interface message list, marking it as sent or received according to the metadata.

The terminal records the message and its status in local storage for history purposes.

The terminal, as output, updates the display state to show the translated message to the user and reflects the delivery status using visual indicators.

### Step 14:

The user reviews the translated message and submits feedback at the terminal.

The terminal, as input, monitors for user interactions associated with the translated message, such as tapping a feedback icon.

The user, upon viewing the translation, selects a rating (for example, a numerical score) and optionally types a comment describing issues or suggestions.

The terminal collects this rating and comment, along with the translation identifier, the original standardized message information, the translated message information, and language pair data.

The terminal constructs a feedback data object that encapsulates this evaluation information and improvement request information.

The terminal, as output, sends the feedback data object to the server as a network message.

### Step 15:

The server aggregates and analyzes feedback to generate characteristic information.

The server, as input, receives feedback data objects from multiple terminals and links each feedback entry to the corresponding translation history entry using the translation identifier.

The server stores the feedback entries in a feedback storage structure and periodically executes aggregation routines that compute metrics such as average rating per language pair, frequency of specific error types extracted from comments, and distribution of errors across domains.

The server performs analysis processing using algorithms such as clustering, classification, or regression to identify patterns in the feedback, for example which phrase types or domains yield low scores.

The server, as output, generates characteristic information relating to translation performance, including quantified error patterns, performance trends, and identified weak areas, and stores this characteristic information for use in subsequent adaptation steps.

### Step 16:

The server generates prompt sentences for a generative AI model based on characteristic information.

The server, as input, reads the characteristic information and relevant subsets of translation history and feedback entries.

The server selects representative error cases and performance summaries and maps them into template-based text structures to form prompt sentences.

For example, the server constructs prompt sentences such as:

“Analyze the following recurring error pattern in translations of time expressions from source language X to target language Y and propose specific changes to decoding parameters and terminology rules.”

or

“Design an improved configuration for a neural machine translation model to increase consistency of business terminology in target language Z, considering the following feedback and examples.”

The server combines fixed template sections with variable sections filled from the characteristic information (such as language pair, domain, and example sentences).

The server, as output, produces human-readable prompt sentences and incorporates them into inquiry information structures prepared for transmission.

### Step 17:

The server sends inquiry information to a generative AI model providing apparatus and receives response information.

The server, as input, takes the inquiry information containing the generated prompt sentences and any associated examples.

The server opens a communication session with the generative AI model providing apparatus and transmits the inquiry information using a suitable protocol.

The generative AI model providing apparatus executes a generative AI model, processes the prompt sentences, and returns response information that may include recommended model configuration changes, updated terminology mappings, or suggested rules and parameters.

The server receives the response information, parses it into structured fields according to predefined parsing rules, and validates the content to ensure it conforms to expected formats.

The server, as output, generates a set of actionable configuration updates or training tasks derived from the response information.

### Step 18:

The server updates translation model configuration and processing parameters based on response information.

The server, as input, receives the parsed and validated configuration updates and training recommendations from the previous step.

The server modifies translation model configuration information in persistent configuration storage, for example by updating mappings from language pairs and domains to specific translation models, adjusting decoding parameters such as beam size or length penalties, or changing thresholds used in terminology consistency processing.

The server may also schedule model fine-tuning jobs that use selected translation history data, especially samples associated with low ratings, as training data, along with appropriate loss functions and optimization parameters.

After training or updating, the server deploys the modified models and configuration settings and records version identifiers.

The server, as output, establishes a new operational state of the translation pipeline that reflects the improvements suggested by the generative AI model and validated by the system, thereby enhancing translation accuracy, consistency, and performance for subsequent requests.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional multilingual communication systems typically rely on a straightforward pipeline in which user input is converted into text, sent to a translation service, and then delivered to a recipient. Such systems exhibit several technical limitations when deployed in environments that require continuous, high-quality, and domain-specific interaction, such as care-support environments. First, these systems do not effectively exploit historical translation data or user feedback at the system level. As a result, the systems repeatedly perform context-free, one-shot translation calls, which leads to inconsistent terminology, unstable writing style, and unnecessary computational load due to repeated translation of similar or identical expressions.

Second, existing systems generally treat user evaluation and correction of translations as passive information, if they collect it at all. Feedback is seldom integrated into the translation pipeline in a structured manner, and there is no mechanism for dynamically adjusting translation vocabularies, translation parameters, or speech output characteristics based on accumulated feedback. This results in a technical bottleneck: the system cannot systematically improve its internal models or processing logic, and therefore cannot reduce future error rates or latency through adaptive optimization.

Third, although generative AI models are capable of analyzing complex patterns and generating refined instructions or linguistic resources, conventional multilingual systems do not integrate such models as active components in the control loop of translation processing. In particular, there is no standardized mechanism to generate structured prompt sentences from machine-readable evaluation data and translation histories, nor to automatically convert model responses into updated translation vocabularies, control parameters, or output expression templates. Consequently, the system cannot technically benefit from large-scale generative models to improve its own internal processing logic over time.

Fourth, prior systems often output synthesized speech with fixed or manually configured parameters, such as volume, speaking rate, and language variant, regardless of user attributes (e.g., hearing capability, age, role in the interaction). This leads to suboptimal audio rendering for different user groups and does not leverage available user attribute information to technically control the audio synthesis pipeline in a fine-grained manner.

Accordingly, there is a need for a computer-implemented system that technically improves multilingual communication processing by: (i) tightly integrating translation history and user feedback into the translation control logic, (ii) employing a generative AI model through systematically constructed prompt sentences to derive updated translation resources and processing parameters, and (iii) adaptively controlling speech synthesis parameters based on user attribute information. Such a system should reduce inconsistency, lower error rates, and improve computational efficiency by avoiding redundant translation work and by continuously refining the underlying processing behavior in a data-driven manner.

The specific processing by the specific processing unit 290 of the data processing device 12 in Application Example 1 is realized by the following means.

The present invention provides a server comprising at least one processor and at least one memory storing instructions that, when executed by the at least one processor, cause the server to cooperate with at least one terminal to acquire an acoustic signal from a user and convert speech included in the acoustic signal into character information; transmit the character information from the terminal to the server via a communication network and return, from the server to the terminal, translation result information and associated control information; generate, at the server, the translation result information based on the character information, translation history information corresponding to the character information, and evaluation information acquired from the user, and control translation processing so as to maintain consistency of terminology and writing style in the translation result information; store and update, at the server, translation vocabulary information, translation processing conditions, and user-oriented expressions based on analysis of the evaluation information and the translation history information; generate, at the server, a prompt sentence to be input to a generative AI model from explanation information including the evaluation information and analysis results, input the prompt sentence to the generative AI model, and automatically adjust at least one of the translation processing conditions and the translation vocabulary information based on a response obtained from the generative AI model; and control, at the terminal, at least one of a volume, a speaking rate, and a language type used in voice synthesis processing in accordance with user attribute information. This enables a technical improvement to computer-implemented multilingual communication processing by closing a feedback loop in which translation outputs, user evaluations, and generative-model-derived updates are integrated into the translation pipeline, thereby enhancing consistency, adaptability, and audio output suitability while reducing redundant computation and improving overall system performance.

The term “system” refers to an arrangement including at least one server, at least one terminal, and associated communication and storage components that cooperate to perform multilingual communication processing as described herein.

The term “processor” refers to one or more hardware processing units, such as a central processing unit, a graphics processing unit, or any other computation circuitry, configured to execute instructions stored in a memory.

The term “memory” refers to one or more non-transitory storage media, such as semiconductor memory, magnetic storage, or optical storage, configured to store instructions and data for access by a processor.

The term “terminal” refers to an information processing apparatus operated by a user, such as a handheld device, a portable device, or a fixed device, configured to acquire user input, communicate with a server, and output translation result information.

The term “server” refers to an information processing apparatus, or a group of such apparatuses, configured to receive data from a terminal, perform translation-related processing, manage history and feedback information, interact with a generative AI model, and return control information and translation result information to the terminal.

The term “acoustic signal” refers to an analog or digital representation of sound, including human speech, acquired by a sound input device and processed for conversion into character information.

The term “speech” refers to audio content produced by a human speaker and included in an acoustic signal, which is subject to recognition and conversion into character information.

The term “character information” refers to digital text data representing the linguistic content of recognized speech or other user input, including symbols corresponding to words, phrases, or sentences.

The term “communication network” refers to any wired or wireless communication infrastructure, including local networks and wide-area networks, that enables data transfer between a terminal and a server.

The term “translation result information” refers to text data produced by translation processing from a source language to a target language, including the final translated expressions delivered to a user.

The term “control information” refers to data representing processing parameters, configuration values, or control signals used to influence translation processing, voice synthesis processing, or display processing in the system.

The term “translation history information” refers to stored records of past translation operations, including pairs of source text and translated text, associated metadata, and usage statistics, used for maintaining consistency and improving translation processing.

The term “evaluation information” refers to data indicating a user's assessment of translation result information, including ratings, error categories, corrections, comments, or other feedback relevant to translation quality or naturalness.

The term “translation vocabulary information” refers to structured data defining term mappings, preferred expressions, glossaries, or domain-specific terminology used to guide or constrain translation processing.

The term “translation processing conditions” refers to parameters and rules that control how translation processing is performed, including language pairs, politeness level, style constraints, domain settings, and model-specific options.

The term “user-oriented expressions” refers to standardized or preferred linguistic formulations intended to be presented to users, including templates, fixed phrases, and tone-adjusted sentences suitable for particular use contexts.

The term “prompt sentence” refers to text data constructed as an instruction or query for a generative AI model, the text data including explanation information and constraints that guide the model's response for translation-related optimization.

The term “explanation information” refers to structured or unstructured data that explains system behavior or issues, including evaluation information, analysis results, error patterns, and contextual descriptions used to form a prompt sentence.

The term “generative AI model” refers to a machine-implemented model, such as a large language model, configured to generate text or other data in response to an input prompt sentence, and used to derive updated translation resources or processing conditions.

The term “response obtained from the generative AI model” refers to output data produced by a generative AI model in reply to an input prompt sentence, including proposed parameter changes, glossary updates, alternative expressions, or other guidance.

The term “voice synthesis processing” refers to processing that converts text data into synthesized audio output representing speech, including analysis of text, generation of prosodic features, and production of digital audio signals.

The term “display processing” refers to processing that converts text data and associated information into visual output on a display device, including layout, font selection, and highlighting.

The term “user attribute information” refers to data describing characteristics of a user, such as age, hearing capability, language preference, role, or other profile information, used to control output parameters and processing conditions.

The term “volume” refers to a level of audio amplitude or loudness in synthesized speech output, which can be adjusted according to user attribute information.

The term “speaking rate” refers to a temporal parameter of synthesized speech output, such as words per minute or duration of phonetic units, which can be controlled to suit user needs.

The term “language type” refers to a specification of a target language or language variant, including dialect, region, or script, used for translation processing and voice synthesis processing.

The term “multilingual dialogue” refers to an interaction in which participants use different languages and rely on the system to perform translation and output processing so that each participant can understand the other.

The term “care-support environment” refers to an operational context in which users include caregivers and care recipients, such as in medical care, nursing care, or welfare facilities, where domain-specific expressions and constraints are applied.

The term “honorific expressions” refers to linguistic forms used to convey politeness, respect, or social hierarchy, which may affect translation style and are subject to adjustment policies in the system.

The term “replacement candidates for frequently used terms” refers to alternative expressions or terms proposed for commonly appearing source expressions, which can be selected to improve naturalness, clarity, or consistency of translation.

The term “analysis result” refers to data obtained by processing evaluation information and translation history information, including statistics, detected patterns, and identified problem areas used to update system resources.

The term “alternative expression candidates” refers to multiple proposed linguistic formulations that can substitute for an existing expression, generated based on a response from a generative AI model or other analysis.

The term “translation memory information” refers to stored data records that pair source sentences with corresponding target sentences and associated metadata, used to retrieve consistent translations for similar or identical source inputs.

The term “terminology information” refers to structured data describing domain-specific terms, their preferred translations, and relevant constraints, used to guide the translation process.

The term “control parameters used during the translation processing” refers to numerical or symbolic values that influence translation model behavior, such as selection of translation engine, decoding strategy, or style constraints.

In one embodiment, a server cooperates with at least one terminal to implement a multilingual communication support system in a care-support environment. The system is configured so that a caregiver or a care recipient can speak in a native language, and another participant can receive a translated and synthesized utterance in a different language. The server and the terminal each execute stored instructions on respective processors to perform audio acquisition, speech-to-text conversion, translation, feedback collection, and adaptive model control using a generative AI model guided by structured prompt sentences.

A terminal includes a microphone, a loudspeaker, a display, a local processor, a memory, and a communication interface. The terminal may be realized by a handheld device, a portable device, or a fixed device. The terminal uses an audio codec to convert an analog acoustic signal into digital samples, for example in linear PCM format at 16 kHz and 16-bit resolution. The terminal applies a noise-suppression algorithm, such as an implementation of a spectral subtraction method or a recurrent-neural-network-based denoiser similar to RNNoise, to suppress ambient noise and emphasize speech. The terminal then segments the audio signal into frames and passes them to a speech recognition software component, which may call a cloud-based automatic speech recognition service or an on-device recognizer. The recognizer uses, for example, a convolutional-recurrent neural network with a connectionist temporal classification loss or an attention-based encoder-decoder model to convert acoustic features (e.g., Mel-frequency cepstral coefficients or log-Mel spectrograms) into character sequences. A server receives recognized character information and associated metadata from the terminal via a communication network. The server runs on one or more hardware computing devices, such as rack-mounted servers or virtual machines, each including a processor and a memory. The server executes software components implemented using, for example, a general-purpose programming language and a web application framework. The server stores translation history information and evaluation information in a persistent data store, such as a relational database. The server maintains data structures including a translation memory table, a vocabulary table, a feedback table, and a configuration table.

The server represents the translation memory information as records each containing a source text, a target text, a source language code, a target language code, a context tag, and one or more quality scores. The vocabulary table contains records for domain-specific terms with fields for canonical form, preferred translation, part-of-speech tag, and usage constraints. The feedback table stores evaluation information including a reference to the translation memory entry, a rating value, an error category, a corrected expression, a user role, and a timestamp. The configuration table stores translation processing conditions, such as politeness level indicators, domain codes, and model selection parameters.

The server uses a translation engine to produce translation result information from the character information received from the terminal. The translation engine may be a cloud-based translation service that internally employs a neural machine translation architecture, such as a sequence-to-sequence model with an attention mechanism or a transformer network. The server optionally pre- and post-processes the text using tokenization rules and custom lexicon replacement rules derived from the vocabulary table. The server performs a lookup in the translation memory by computing vector representations of the source text, for example using a sentence-embedding model such as a bidirectional transformer encoder trained with a contrastive objective. The server computes cosine similarity between the current source text vector and stored source text vectors. When the similarity exceeds a threshold, the server retrieves a corresponding stored translation result and uses it preferentially or uses it to post-edit the translation engine output to maintain consistent terminology and style.

The server analyzes evaluation information periodically or incrementally. The server aggregates low-rated translations and identifies patterns such as recurring source phrases, frequent error categories, or mismatched politeness levels. The server uses statistical methods, such as computing frequency counts and conditional probabilities, and may also cluster problematic segments using unsupervised algorithms. The server stores the analysis result as structured data, including lists of problematic phrases, suggested replacement candidates, and parameter adjustment recommendations.

The server constructs a prompt sentence for a generative AI model by concatenating textual descriptions of the identified issues, domain context, and desired constraints. The server uses a predefined template where slots are filled by structured fields from the analysis result and translation history information. Example prompt sentences include the following:

“Analyze the following caregiver-to-resident Japanese instructions and their translations into Vietnamese used in a nursing-home communication system. Identify cases where the tone is too direct for elderly residents and propose softer, culturally appropriate alternatives with the same medical meaning.”

“Design a multilingual communication support system for use in care facilities. Focus on robust speech-to-text conversion, neural machine translation with medical terminology handling, and text-to-speech output optimized for elderly users with hearing impairments.”

“Optimize the process that converts noisy Japanese speech in a care facility into high-accuracy text and translates it into Vietnamese, Chinese, and English, with special handling of medical terms and polite expressions. Propose control parameters and glossary entries that reduce inconsistency and translation errors over time.”

“Propose an interface and data schema for collecting user feedback on translation accuracy and naturalness, and describe how this feedback should be used to automatically refine translation glossaries and model prompts.”

The server transmits the prompt sentence, along with example source-target pairs and feedback summaries, to a generative AI model. The generative AI model may be implemented as a large language model with a transformer architecture, including multiple self-attention layers, feed-forward layers, and layer normalization. The model is trained on large-scale text corpora using masked-language-modeling and next-token prediction objectives, and fine-tuned on instruction-following data. The server sends the prompt sentence and additional context in a single request, controlling parameters such as maximum output length and sampling temperature.

The server receives a response from the generative AI model in the form of text that includes proposed updated vocabulary entries, alternative expression templates, and recommendations for translation processing conditions. The server parses the response using rule-based or pattern-matching logic to extract structured proposals. The server uses a set of non-conventional rules that map linguistic suggestions into concrete configuration changes.

For example, when the generative AI model suggests using softer modal verbs in a particular language for caregiver instructions, the server translates this suggestion into a rule that maps specific source phrases to preferred target patterns and updates the vocabulary table and translation memory entries accordingly.

The server may compute a confidence measure for each suggested change based on, for example, the frequency of related feedback items and the consistency of suggestions across multiple model invocations. The server writes only suggestions whose confidence exceeds a threshold into the persistent configuration. Alternatively, the server can present a ranked list of suggestions to a user, such as a lead caregiver or system administrator, through an administrative interface. The user can review, accept, or reject each proposal. When the user accepts a proposal, the server commits the proposal to the translation vocabulary information or translation memory information.

The terminal uses the translation result information and associated control information received from the server to generate an audio output. The terminal invokes a text-to-speech engine running locally or in a network-accessible service. The text-to-speech engine may use a neural vocoder model, such as a waveform generative network, and a sequence-to-sequence text-to-mel-spectrogram model. The terminal sets parameters such as volume, speaking rate, and voice profile based on user attribute information stored in a local profile database or received from the server. The terminal adjusts these parameters programmatically by calling audio subsystem interfaces so that residents with hearing impairments receive louder and slower speech, while other users receive default settings.

The server maintains user attribute information as structured records containing at least a user identifier, a role indicator (e.g., caregiver or care recipient), a preferred language code, hearing capability attributes, and any special output requirements. The server transmits the relevant attributes to the terminal so that the terminal can control audio output. Because the terminal uses explicit parameters derived from user attribute information, the system performs audio rendering in a data-driven and automated manner that is tied to physical device settings, thereby improving intelligibility and usability beyond manual adjustment.

The server improves computational efficiency and reduces communication load by reusing translation memory entries and minimizing redundant calls to external translation engines.

When the server identifies a high-similarity match in the translation memory, the server can bypass the neural translation model and immediately return a stored translation. This reduces processing latency and external service usage. Furthermore, by integrating evaluation information and analysis results into the generative AI-driven update cycle, the server improves the quality of the translation memory and vocabulary over time, which reduces the number of problematic translations causing re-queries and corrective feedback.

The server controls the generative AI model as a subsystem with defined inputs and outputs, rather than simply delegating human judgment. The server uses explicit feature vectors, similarity metrics, feedback statistics, and rule-based mappings from generative suggestions to parameter updates. This configuration ensures that the system follows a non-conventional processing flow: the server uses structured error signals from actual deployments, transforms them into targeted prompt sentences, and then interprets model responses through deterministic rules. This approach differs from mere human-like editing and achieves a technical effect on the internal configuration of the translation engine, leading to measurable improvements in translation accuracy, consistency, and runtime efficiency.

In one alternative embodiment, the server executes the speech recognition and text-to-speech synthesis locally, without reliance on external services. The server deploys an automatic speech recognition model, such as an encoder-decoder network with self-attention, trained using a cross-entropy loss or a connectionist temporal classification loss. The server updates model weights using a gradient-based optimization algorithm, such as stochastic gradient descent with momentum or an adaptive learning-rate variant, and applies data augmentation methods such as noise injection and speed perturbation. By retraining or fine-tuning the models with domain-specific data drawn from the translation history information, the server further improves recognition accuracy in noisy care-facility environments.

In another embodiment, the server employs multiple translation engines specialized for different language pairs or domains. The server uses control information derived from the generative AI model to select an appropriate engine dynamically for a given request. For example, the server may route medically sensitive expressions to a model trained on clinical text, while general conversational content is processed by a general-domain model. The generative AI model may propose new routing rules based on observed error patterns, and the server encodes these rules as entries in a routing table. This modular architecture enables reduced error rates and more efficient use of computational resources by aligning engine capabilities with specific translation tasks.

The system as implemented by the server and the terminal is not limited to static data retrieval or mere automation of human translation work. The server employs feedback-driven adaptive control of translation resources and audio rendering parameters, uses specific neural architectures and data structures, and enforces a non-conventional loop involving translation history, evaluation information, generative AI output, and deterministic parameter update rules. These technical measures collectively improve computer-implemented multilingual communication processing in terms of speed, accuracy, and consistency, and optimize control of real-world hardware components such as microphones, speakers, and displays. As a result, the system achieves a technical effect that extends beyond a generic business or administrative process and constitutes an improvement in computer technology itself.

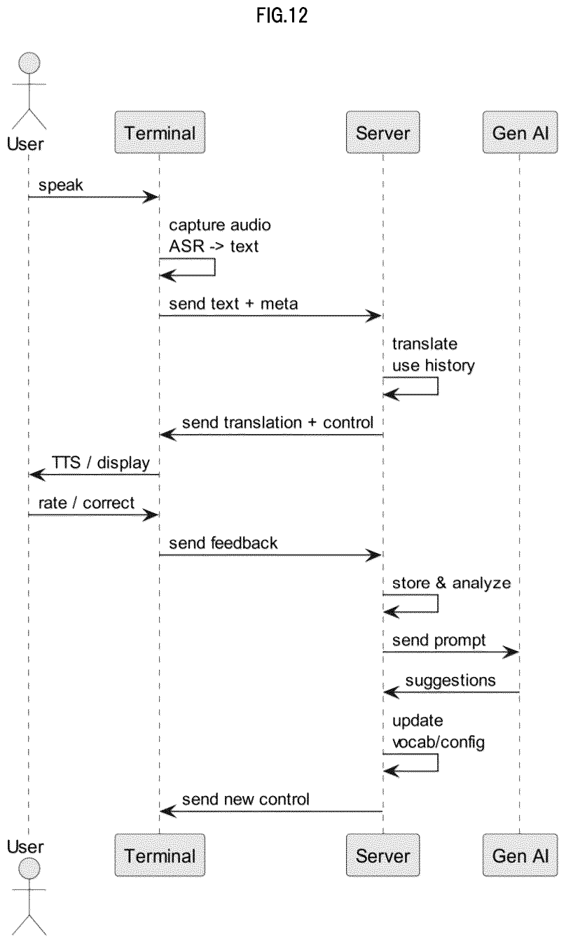

The following describes the processing flow using FIG. 12.

### Step 1:

Terminal acquires an acoustic signal from a user through a microphone and converts the acoustic signal into digital audio samples.

Terminal receives, as input, an analog sound pressure wave produced by the user's speech.

Terminal uses an audio codec to sample this signal at a predetermined sampling rate (for example, 16 kHz) and quantization bit-depth (for example, 16 bits), thereby producing a sequence of digital samples as output. Terminal performs a data conversion operation from continuous-time analog values to discrete-time numerical values that can be processed by software modules.

### Step 2:

Terminal performs noise suppression and feature extraction on the digital audio samples. Terminal receives, as input, the digital audio sample sequence from Step 1. Terminal applies a noise-reduction algorithm, such as spectral subtraction or recurrent-neural-network-based denoising, to attenuate background noise and preserve the speech components. Terminal then segments the cleaned audio into overlapping frames and computes acoustic features, such as Mel-frequency cepstral coefficients or log-Mel spectrograms, by applying a short-time Fourier transform and a Mel-filterbank. Terminal outputs a feature matrix in which each frame is represented by a feature vector. This processing converts raw waveform samples into a compact numerical representation suitable for pattern recognition.

### Step 3:

Terminal executes automatic speech recognition to convert the acoustic features into character information.

Terminal receives, as input, the feature matrix from Step 2. Terminal feeds the feature vectors into a speech recognition model, such as an encoder-decoder recurrent neural network or a transformer-based model trained with a sequence loss function. Terminal computes, for each time step, probability distributions over characters or subword units and then decodes the most likely sequence using a decoding algorithm, such as beam search with a language model. Terminal outputs recognized text (character information), along with metadata such as confidence scores and language identifiers. This operation performs a mapping from time-series feature vectors to symbolic text representations.

### Step 4:

Terminal generates a request payload including character information and context and transmits it to the server.

Terminal receives, as input, the recognized text and metadata from Step 3 and local context such as user role, target language preference, and session identifier. Terminal constructs a structured data object containing fields for source text, source language code, target language code, user role, and timestamps. Terminal sends this data object to the server via a communication interface using a network protocol. Terminal outputs a network message that encapsulates all necessary information for subsequent translation processing.

### Step 5:

Server receives the request payload and stores relevant data in persistent storage. Server receives, as input, the network message transmitted in Step 4. Server validates the structure and content of the message, extracts the character information and associated metadata, and writes them into a database. Server stores the source text, language codes, user role, and timestamps as records in translation history information. Server outputs a normalized internal representation of the request, including a database key that identifies the stored entry. This step transforms a transient network message into a durable, queryable data structure.

### Step 6:

Server performs translation processing to generate translation result information. Server receives, as input, the normalized request representation from Step 5. Server determines an appropriate translation engine and translation processing conditions based on the source and target language codes, user role, and configuration parameters. Server sends the source text to a translation engine, which may be a neural machine translation model. Server receives a candidate translation as output and then applies post-processing rules such as token normalization and glossary enforcement. Server outputs provisional translation result information, including the translated text and status flags. This step executes a data transformation from source language text to target language text under defined constraints.

### Step 7:

Server consults translation history information to ensure consistency of terminology and style. Server receives, as input, the provisional translation result information and the database key from Step 6. Server retrieves prior translation records whose source texts are similar to the current source text by computing sentence embeddings and similarity scores against stored entries. Server compares the current provisional translation with previously accepted translations. Server modifies the provisional translation, when appropriate, by replacing terms or phrases to align with preferred expressions stored in translation memory. Server outputs a refined translation result that maintains consistent terminology and style across sessions. The server thus performs a comparison and adjustment operation based on historical data.

### Step 8:

Server returns the refined translation result information and associated control information to the terminal.

Server receives, as input, the refined translation result and configuration parameters such as politeness level, output mode, and any flags indicating special handling. Server constructs a response message that contains the translated text and control information specifying how the terminal should render the output (e.g., audio, text, or both). Server transmits this message through the communication network to the terminal. Server outputs a network response that delivers both content and rendering instructions derived from its internal processing.

### Step 9:

Terminal stores the translation result information and prepares for output presentation. Terminal receives, as input, the network response from Step 8. Terminal parses the response to extract the translated text and control information. Terminal writes the source text and translated text, along with timestamps and session identifiers, into a local storage area for later reference (for example, a conversation log). Terminal outputs an internal representation ready for audio and/or visual rendering, and may also update a user interface state to indicate that new content is available.

### Step 10:

Terminal executes voice synthesis processing based on translation result information and user attribute information.

Terminal receives, as input, the translated text, control information, and user attribute information such as hearing capability and preferred language variant. Terminal adjusts text-to-speech parameters, such as target language type, volume level, speaking rate, and voice profile, according to the control information and user attributes. Terminal passes the translated text and these parameters to a text-to-speech engine, which generates digital audio samples representing synthesized speech. Terminal outputs the synthesized audio signal and transmits it to the loudspeaker. This step performs a conversion from symbolic text to time-domain audio signals while enforcing user-specific constraints.

Step 11: User listens to or views the translated output and, optionally, provides evaluation information and corrections.

User receives, as input, the audio rendering from the loudspeaker and/or the text displayed on the terminal screen. User assesses the quality and naturalness of the translation result and may interact with a user interface to submit a rating, select an error category, or enter a corrected expression. User thereby outputs evaluation information and correction text that reflect perceived translation quality and context suitability.

### Step 12:

Terminal packages the evaluation information and correction text and sends them to the server.

Terminal receives, as input, the user's rating, selected error category, and any manually entered corrected expression from Step 11. Terminal constructs a feedback payload that links this evaluation information to the corresponding translation history entry using identifiers stored locally. Terminal sends this payload to the server using the communication interface.

Terminal outputs a structured feedback message that contains all fields required for downstream analysis.

### Step 13:

Server stores the evaluation information and associates it with translation history information. Server receives, as input, the feedback message from Step 12. Server verifies the linkage between the feedback and the referenced translation entry and then inserts a new record into the feedback table. Server stores fields including the rating value, error category, corrected expression, user role, and timestamp. Server outputs an updated database state where each translation entry may have zero or more associated feedback records. This step performs a data association operation that connects user evaluations with prior translation results.

### Step 14:

Server analyzes accumulated evaluation information and translation history information to derive analysis results.

Server receives, as input, all relevant feedback records and associated translation history records. Server executes statistical and algorithmic processing, such as computing frequency distributions of error categories, aggregating average ratings per source phrase, and identifying phrases with repeated low scores. Server may compute vector representations of phrases and cluster them to find groups with similar error patterns. Server outputs analysis results, including lists of problematic source expressions, recommended replacement candidates, and suggested updates to translation processing conditions. This analysis transforms dispersed feedback data into structured knowledge about systematic issues.

### Step 15:

Server generates a prompt sentence for a generative AI model based on the analysis results and explanation information.

Server receives, as input, the analysis results from Step 14 and contextual data such as domain description, language pairs, and system configuration. Server assembles a prompt sentence by inserting key elements of the analysis results into a predefined textual template. For example, server may generate a prompt sentence that describes specific problematic phrases, observed user reactions, and desired stylistic constraints. Server outputs a composed prompt sentence in plain text, which serves as an input query for a generative AI model.

### Step 16:

Server transmits the prompt sentence and supporting examples to the generative AI model and obtains a response.

Server receives, as input, the prompt sentence from Step 15 and optionally a set of example source-target pairs and associated feedback metrics. Server sends these as request parameters to the generative AI model using a communication interface. Server then receives a textual response that proposes alternative expressions, updated glossary entries, or adjustments to translation processing conditions. Server outputs this response as raw generative output to be further processed. This step performs a transformation from structured analysis data to natural-language suggestions produced by the generative AI model.

### Step 17:

Server parses the response from the generative AI model and converts it into structured update proposals.

Server receives, as input, the generative output from Step 16. Server applies parsing rules, pattern matching, or simple natural-language understanding techniques to extract candidate vocabulary entries, expression templates, and control parameter recommendations. Server converts these items into structured records with fields such as source pattern, proposed translation, tone attribute, and priority level. Server outputs a set of structured update proposals that can be applied to translation vocabulary information and translation processing conditions. This step converts free-form model output into machine-interpretable configuration data.

### Step 18:

Server updates translation vocabulary information, translation memory information, and translation processing conditions based on the structured update proposals.

Server receives, as input, the structured proposals from Step 17 and existing configuration data. Server evaluates each proposal, optionally checking confidence scores or consistency with historical data. Server inserts new entries or modifies existing entries in the vocabulary table and translation memory table, such as adding a preferred translation for a recurring phrase or altering politeness level tags. Server also adjusts translation processing conditions, for instance by changing rules that control selection of translation engines or style parameters.

Server outputs an updated configuration state that influences all subsequent translation processing operations.

### Step 19:

Server sends updated control information to terminals so that terminals can adjust output behavior.

Server receives, as input, the revised configuration and user attribute changes resulting from Step 18. Server generates control messages that specify new output parameters, such as default speaking rate adjustments for particular user profiles or new preferred language variants. Server transmits these control messages to terminals over the network. Server outputs configuration updates that terminals use to align their voice synthesis and display behavior with the improved translation settings.

### Step 20:

Terminal applies updated control information and user attribute information in subsequent translation cycles.

Terminal receives, as input, control messages from Step 19 and merges them with locally stored user attribute information. Terminal updates local configuration parameters used in text-to-speech processing and user interface rendering, such as default volume for a specific user, font size, and language type selection. Terminal outputs modified operational settings that affect how future translation results are synthesized and presented. By doing so, the terminal closes the loop between user feedback, server-side analysis, generative AI-driven updates, and device-level behavior in subsequent processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional machine translation systems are primarily designed to map input text from a source language to a target language on a purely lexical and syntactic basis. Such systems, including those that leverage large-scale neural networks, typically ignore or only superficially consider the underlying user emotion and the communication context in which a message is used. As a result, the tone of a translated message may become unnecessarily aggressive, overly weakened, or otherwise inappropriate for the intended communication scenario, such as business correspondence, negotiations, or highly sensitive interpersonal exchanges. This mismatch between the sender's intended emotional nuance and the receiver's perception can cause misunderstandings, deterioration of business relationships, and additional manual correction work by human operators.

Further, conventional architectures often treat translation quality improvement as an offline, batch-oriented process. User feedback about meaning accuracy and tone appropriateness, if collected at all, is not systematically linked to the specific emotion state and tone control decisions that produced a given translation. Existing systems typically lack a structured pipeline that (i) captures detailed feedback together with the original message, the emotion estimation, and the applied tone control parameters, and (ii) feeds this linked information back into models and rules in an automated and continuous manner. Consequently, these systems are slow to adapt to user preferences, domain-specific tone requirements, and evolving communication norms.

Moreover, although generative artificial intelligence models have demonstrated powerful capabilities for generating natural language, there is no standardized computer-implemented mechanism for integrating such models into the lifecycle of an emotion-aware translation system. In particular, existing systems do not define how to automatically construct prompt sentences from real feedback data, how to extract structured rules and phrase candidates from generative outputs, or how to safely incorporate those rules into the core translation and tone control pipeline. The lack of such integration limits the ability of the system to leverage generative AI for rapid rule design, fine-grained phrase substitution, and algorithm tuning. From a computer technology perspective, these limitations manifest as rigid, weakly adaptive pipelines, in which: (i) the emotion recognition and translation components are not tightly coupled to runtime feedback; (ii) configuration of tone control parameters remains largely static or manually curated; and (iii) generative AI capabilities are not exploited in a controlled, data-driven manner. There is therefore a need for a computer-implemented architecture that systematically closes the loop between user input, emotion estimation, tone-controlled translation, user feedback, and generative AI-assisted rule updating, thereby improving the overall processing performance, adaptability, and robustness of the translation system as a computing system.

The specific processing by the specific processing unit 290 of the data processing device 12 in Example 2 is realized by the following means.

The present invention provides a server comprising a processor configured to execute an integrated pipeline including: receiving, from an information processing apparatus operated by a user, message data expressed in a natural language together with language designation information and emotion reflection policy information; performing, by applying a machine learning model, emotion recognition processing on the message data to calculate an emotion label and an emotion score; determining, with reference to a rule table and on a basis of the emotion label and the emotion reflection policy information, tone control parameters including at least a politeness level, a mitigation degree of aggressive expressions, and a permissibility degree of colloquial expressions; generating, on a basis of the tone control parameters and the language designation information, translation request parameters for a neural network based translation model or an external translation service, and causing the neural network based translation model or the external translation service to generate translation result data in a target language; generating and transmitting, to the information processing apparatus, response data including the translation result data, the emotion label, and the tone control parameters; receiving, from the information processing apparatus, feedback information including at least an evaluation regarding meaning accuracy, an evaluation regarding tone appropriateness, and comment information associated with the translation result data; storing, in a storage device, a correspondence among the feedback information, the message data, and the translation result data; updating, on a basis of stored information, at least one of a model, parameters, and translation rules used by the emotion recognition processing or by translation processing so as to improve processing performance; generating, on a basis of the stored feedback information and the translation result data, a prompt sentence to be input to a generative artificial intelligence model; transmitting the prompt sentence to the generative artificial intelligence model and receiving, from the generative artificial intelligence model, a response including candidate expressions and tone control rule proposals; extracting, from the response, at least one of substitution rules and tone control rules; and updating at least one of the tone control parameters and the translation rules on a basis of the extracted rules. This enables a computer-implemented translation system in which the emotion recognition, tone control, and translation components are dynamically adapted in response to actual user feedback, and in which a generative artificial intelligence model is programmatically leveraged via prompt sentences to derive and refine phrase substitution rules and tone control logic, thereby improving the technical performance, adaptability, and context sensitivity of the translation pipeline as a whole.

The term “information processing apparatus” refers to an electronic device that includes at least a processor, a memory, a user interface, and a communication interface, and that is operated by a user to input messages, display translation results, and transmit and receive data with a server.

The term “message data” refers to digital data representing a user's message expressed in a natural language, including at least a character string obtained from text input, speech recognition, or handwriting recognition, and formatted as a unified character string for processing.

The term “language designation information” refers to information indicating a target language into which the message data is to be translated, including at least a language identifier such as a language code managed by the system.

The term “emotion reflection policy information” refers to information specifying how an estimated user emotion is to be reflected in a translation result, including at least a policy type that distinguishes between business-oriented mild tone, emotion-preserving tone, and casual or direct tone.

The term “encrypted communication path” refers to a communication channel established between an information processing apparatus and a server, in which message data and control information are transmitted using a cryptographic protocol to ensure confidentiality and integrity.

The term “machine learning model” refers to a computational model generated by training on data using a machine learning algorithm, and that is capable of mapping input data, such as message data or extracted features, to output values, such as emotion labels and emotion scores.

The term “emotion recognition processing” refers to processing in which a machine learning model is applied to message data and optionally additional features to estimate at least one emotion label and one or more emotion scores corresponding to the message data.

The term “emotion label” refers to symbolic data indicating a category of emotion associated with message data, including at least categories such as anger, joy, sadness, anxiety, surprise, and neutrality.

The term “emotion score” refers to numerical data indicating a strength, probability, or confidence value associated with each of a plurality of emotion labels for given message data.

The term “tone control parameters” refers to control data used to adjust the tone and style of a translation result, including at least a politeness level, a mitigation degree of aggressive expressions, and a permissibility degree of colloquial expressions.

The term “rule table” refers to stored data that associates combinations of at least an emotion label and emotion reflection policy information with corresponding tone control parameters, and that is referenced by the processor during tone control.

The term “neural network based translation model” refers to a translation model implemented using an artificial neural network, including at least an encoder-decoder architecture, that converts message data from a source language to translation result data in a target language.

The term “external translation service” refers to a translation functionality provided by a system or service distinct from the server, accessible via a communication interface, and capable of receiving text and language designation information and returning translation result data.

The term “translation result data” refers to digital data representing text obtained by translating message data into a target language by means of a neural network based translation model or an external translation service.

The term “response data” refers to data generated by the server and transmitted to an information processing apparatus, including at least translation result data, an emotion label, and tone control parameters.

The term “feedback information” refers to information acquired from a user regarding quality of a translation result, including at least an evaluation regarding meaning accuracy, an evaluation regarding tone appropriateness, and optionally labels or categories indicating perceived issues.

The term “comment information” refers to free-form textual data provided by a user to describe impressions, issues, or requests concerning a translation result, and associated with feedback information.

The term “storage device” refers to a physical or virtual storage resource, such as a non-volatile memory device or a database system, used to store message data, translation result data, feedback information, and associated correspondence data.

The term “translation rules” refers to rules used during translation processing or post-processing, including at least phrase substitution rules, expression softening rules, and mappings between control tokens and tone settings, that influence generation of translation result data.

The term “generative artificial intelligence model” refers to a machine learning model that generates output data, including at least natural language text, in response to input data, and that is capable of producing candidate expressions, rule descriptions, and algorithm proposals based on prompt sentences.

The term “prompt sentence” refers to a natural language instruction text constructed by the server and provided as input to a generative artificial intelligence model, specifying at least context, constraints, and requested output format for generating candidate expressions and rule proposals.

The term “candidate expressions” refers to alternative textual expressions generated by a generative artificial intelligence model in response to a prompt sentence, and intended to replace or supplement existing translation expressions for improved tone or appropriateness.

The term “tone control rule proposals” refers to rule descriptions generated by a generative artificial intelligence model, indicating how tone control parameters or translation rules should be configured or adjusted under specified emotion and policy conditions.

The term “substitution rules” refers to rules that define replacement of a first expression by a second expression, including at least replacement of aggressive or strong expressions with mitigated or more polite expressions in translation result data.

The term “control tokens” refers to symbolic tokens or markers that are prepended to or embedded in input sequences for a neural network based translation model to influence behavior of the model with respect to tone, politeness, emotion reflection, or other style attributes.

The term “update logic” refers to a computational procedure or algorithm used by the processor to numerically adjust tone control parameters, translation rules, or model parameters based on statistical values or patterns observed in feedback information.

In the following embodiments, “terminal” denotes an information processing apparatus operated by a user, and “server” denotes one or more information processing apparatuses in a data center or cloud environment. “User” denotes a human operator who interacts with the terminal.

Terminal operates under a general-purpose operating system, such as a mobile operating system or a desktop operating system, and includes at least a display device, an input device such as a touch panel or keyboard, a microphone, a speaker, a non-volatile storage device, and a network interface. Terminal executes a client application implemented, for example, using a mobile application framework or a web application framework.

Server operates under a server operating system, such as a UNIX-like operating system, and includes at least a multi-core central processing unit, a main memory, one or more accelerator devices such as graphics processing units, a non-volatile storage device, and a network interface. Server executes application server software implemented, for example, using a general-purpose web application framework. Server further executes a machine learning framework such as PyTorch or TensorFlow, and an associated natural language processing library such as a transformer-based toolkit, to perform neural network inference.

Terminal acquires user input by using hardware and software components in combination. Terminal uses an operating system input subsystem to receive key events from a software keyboard and aggregates the key events into a UTF-8 encoded character string stored in a memory region dedicated to message data. Terminal uses a built-in audio driver to acquire pulse-code-modulated audio samples from the microphone, buffers the samples in a ring buffer, and transmits the samples to a speech recognition framework, such as a platform speech-to-text API or a cloud-based speech recognition service. Terminal receives a recognized character sequence and converts the recognized sequence into a normalized UTF-8 message string. Terminal also acquires handwriting input by reading pointer coordinate sequences from a touch panel driver, grouping the coordinates into stroke sequences, and passing the stroke sequences to a handwriting recognition library. The handwriting recognition library returns a character sequence, which the terminal converts into the same normalized UTF-8 message string representation. As a result, the terminal unifies heterogeneous input modalities into a single text representation, reducing downstream branching logic and enabling efficient memory management.

Terminal stores the normalized message string in a dedicated message buffer region and associates the buffer with a message identifier generated by a monotonically increasing counter or a universally unique identifier generator. Terminal further maintains, in a local key-value storage, configuration entries for a target language and an emotion reflection policy, represented by short language codes and policy codes. Terminal reads these codes from storage and combines them with the message string into a structured in-memory data object. Terminal serializes this object into a text-based interchange format such as JSON, using a platform JSON library. Terminal transmits the serialized data to the server via an encrypted channel, for example, a TLS-secured HTTPS connection, thereby ensuring confidentiality and integrity at the transport layer and preventing intermediate nodes from accessing message content.

Server receives the serialized request at an HTTP endpoint implemented by a web application framework. Server passes the request body to a JSON parser, converts the body into an internal data structure, and extracts text content, target language code, and emotion policy code. Server allocates memory buffers to store the text and metadata and references these buffers by request identifiers. Server then initiates emotion recognition processing.

Server implements emotion recognition by using a transformer-based neural network architecture. Server uses a tokenizer, such as a byte-pair-encoding or wordpiece tokenizer, to segment the input text into subword tokens and map the tokens to integer identifiers. Server constructs a fixed-length tensor by padding or truncating the sequence and transfers the tensor to a graphics processing unit memory via a device transfer command of the machine learning framework. Server executes a forward pass through a pre-trained language representation model, such as a multi-layer self-attention network, fine-tuned for emotion classification. In the final layer, server applies a linear projection to obtain unnormalized scores (logits) for each emotion class, including at least anger, joy, sadness, anxiety, surprise, and neutrality, and then applies a softmax operation to obtain a probability vector.

Server interprets the probability vector by selecting the class index having the maximum probability as the emotion label. Server stores both the label and the full probability vector in memory as the emotion scores. When audio features are available, server performs additional feature extraction by applying a signal processing library to the audio waveform, computing features such as Mel-frequency cepstral coefficients, pitch contour features, and energy statistics. Server feeds these features into a separate neural network classifier specialized for audio emotion recognition. Server combines text-based and audio-based probabilities by computing a weighted sum of the probability vectors and normalizes the result. This fusion improves robustness in noisy conditions and reduces misclassification caused by ambiguous textual patterns.

Server determines tone control parameters by using a rule table stored, for example, as a YAML or JSON configuration file on a storage device. Server loads the rule table at application startup and maps each pair consisting of an emotion label and an emotion reflection policy to a structured tone parameter record. The record includes a politeness level encoded as a discrete integer or ordinal category, an aggressiveness mitigation factor represented as a floating-point weight within a predefined range, and a colloquial expression allowance represented as a binary flag or a scalar weight. Server looks up the record corresponding to the current emotion label and policy and obtains the tone parameters. Because these tone parameters are represented as compact structured data, server can efficiently propagate them through subsequent translation modules and maintain explainability of the system's behavior.

Server uses the tone control parameters as conditioning information for translation. In one embodiment, server uses a neural network based translation model implementing an encoder-decoder transformer architecture. Server constructs an augmented source sequence by concatenating control tokens with the input text. The control tokens explicitly encode the source language, the target language, and the tone configuration. For example, when a Japanese message is translated into English with a business-mild policy and an anger label, server constructs the following prefix:

[SRC=JA][TGT=EN][TONE=POLITE][SOFTEN_ANGER]

Server concatenates this prefix with the tokenized source text and feeds the entire sequence to the encoder of the translation model. The presence of control tokens biases the attention mechanisms and output distributions without requiring a distinct model for each tone. This configuration improves computational efficiency by sharing model parameters across multiple tone configurations and allows real-time switching between styles without reloading models. Server executes the encoder-decoder transformer on a graphics processing unit. Server uses beam search in the decoder, maintaining multiple candidate hypotheses at each decoding step and computing cumulative log-probabilities. Server terminates decoding when an end-of-sequence token is generated or a maximum length is reached. Server selects the candidate sequence with the highest normalized score as the translation output. Because the tone control tokens and parameters influence the distribution from which tokens are sampled, the model prefers more polite and softened wording in business contexts, which is empirically shown to reduce user feedback indicating “too harsh” tone.

In another embodiment, server uses an external translation service. Server constructs a request containing the source text, target language, and tone-related hints such as formality levels and profanity filters, if supported by the external service. Server transmits the request via HTTPS and receives a translated text. Server optionally applies a post-processing pipeline, which uses a phrase substitution table derived from tone control rules, to further adjust the tone of the translated text. This hybrid approach enables integration with existing translation infrastructure while still taking advantage of the proposed emotion-aware tone control.

Server then constructs response data including at least the translated text, the emotion label, and the tone control parameters. Server serializes this data into JSON and sends the response via the encrypted channel back to the terminal. Terminal parses the JSON, extracts the translated text, and displays it in a conversation-style user interface on the display device.

Terminal may also indicate the detected emotion and applied tone, for example, via icons or color themes, thereby providing transparency to the user.

User evaluates the translated output by manipulating user interface elements, such as sliders for meaning accuracy and tone appropriateness, checkboxes indicating perceptions like “too harsh” or “too weak,” and a text field for free comments. Terminal aggregates the evaluation values and comment into a feedback object, associates the object with identifiers of the original message and translation, and transmits the feedback to the server.

Server stores the feedback in a database system implemented, for example, as a relational database or a document-oriented database. Server creates records that include message identifiers, translation identifiers, emotion labels, tone parameters, numeric scores, and free-text comments. Server maintains indices on key fields, such as emotion label and tone score, to support efficient retrieval of specific subsets of feedback. This structured storage of feedback, linked at a fine-grained level to both the original message and the translation, enables subsequent automated analysis without manual data alignment.

Server periodically analyzes stored feedback to improve the emotion recognition model, translation rules, and tone parameters. Server selects records in which tone appropriateness falls below a threshold, or in which comments indicate dissatisfaction with tone. Server composes prompt sentences for a generative AI model by embedding specific examples into predefined templates. For instance, server may generate the following prompt sentence: “You are a design assistant for an emotion-aware translation system.

The following data consists of a Japanese source sentence, an English translation result, the estimated emotion, and the user's tone evaluation.

Source: “I am very dissatisfied with their response. (in Japanese)”

Emotion label: anger

Translation: ‘I am very dissatisfied with their response.’

User evaluation: meaning accuracy 5/5, tone appropriateness 2/5, comment ‘Too strong for a business context.’

Please propose three English phrasing options suitable for a business email that express the anger in a milder way.

Also, generalize the control rules (vocabulary substitutions, changes to more polite expressions) that should be applied by the translation model in such cases.”

In another example, server generates a prompt sentence describing mapping rules between emotion labels, policies, and control tokens:

“You are a design assistant for a multilingual, emotion-aware translation system.

For each combination of an emotion label (anger, joy, sadness, anxiety, surprise, neutrality) and an emotion reflection policy (BUSINESS_MILD, CASUAL_DIRECT, EMOTION_PRESERVE),

propose control tokens (for example, [POLITE], [SOFTEN_ANGER]) that should be attached to the source text so that the translation model produces text with an appropriate tone.

Output the mapping as a table of (emotion, policy)→control token sequence.”

Server transmits such prompt sentences to a generative AI model, such as a large language model provided as a service or deployed locally on a server cluster. Server sets parameters such as temperature and maximum output length to constrain generated output. Server receives responses containing alternative expressions and descriptions of potential rules. Server then applies pattern extraction procedures, such as rule-based parsers or regular expression engines, to extract structured substitution rules and control token mappings from the text.

Server does not simply replace human work with automation in a straightforward manner; instead, server defines a feedback-driven optimization loop that is not feasible with manual processes. Server automatically mines misaligned cases from large volumes of data, constructs precise prompt sentences that capture actual system failures, and converts generative model outputs into machine-readable rules and parameter updates. Because the rules are expressed in a structured format and are integrated into the tone control and translation modules, the system can rapidly adapt to emerging communication patterns with minimal human intervention. At the same time, the server may present candidate rules to an administrator interface for optional human approval when stricter control is desired.

From a computer-technical perspective, this architecture improves processing speed, accuracy, and resource efficiency. Server avoids retraining large models for every minor tone adjustment by encoding tone as control tokens and lightweight parameter sets, allowing a single model instance on a graphics processing unit to handle a wide range of tone configurations with shared parameters. Server reduces communication load by transmitting compact structured parameters and identifiers instead of repeatedly transmitting full rule sets or model weights. Server improves data management by linking each translation instance to emotion labels, tone parameters, and feedback in a normalized relational schema, which in turn supports efficient query execution and incremental learning.

Server further implements training and updating of the emotion recognition model and optional tone-aware translation model by using supervised learning techniques. Server defines a loss function, such as cross-entropy, that penalizes incorrect emotion classification or inappropriate tone levels. Server computes gradients of the loss with respect to model weights via backpropagation, and updates weights using optimization algorithms such as stochastic gradient descent or adaptive optimization. Server may employ data augmentation strategies, such as paraphrase generation or noise injection, to improve generalization. By integrating feedback that explicitly labels outputs as “too harsh” or “too weak,” server adjusts not only lexicon-level rules but also continuous model parameters that govern how control tokens influence output distributions. This coupling between discrete rules and continuous parameters leads to more stable and efficient updates than manual rule tuning.

In one embodiment, server partitions the tone control logic into rule-based and learned components. The rule-based component applies deterministic substitution rules extracted from the generative AI model's proposals, such as replacing “very dissatisfied” with “quite concerned” under specific emotion and policy conditions. The learned component treats aggressiveness and politeness as continuous features in the decoder and modifies logits during decoding by adding or subtracting weights proportional to an aggressiveness mitigation factor. This hybrid design allows server to implement non-conventional processing steps that are not typical of standard translation pipelines, and that specifically reduce variance in user perception of tone while maintaining semantic fidelity.

User experiences the technical benefits of this system when participating in time-sensitive communication, such as live international meetings. Terminal and server collaboratively produce translations that not only convey meaning but also maintain an appropriate emotional tone automatically. Because emotion recognition, tone control, and translation are integrated into a single pipeline optimized for low latency and high throughput on specialized hardware, the system can support real-time use without the delays typically associated with manual review and correction. The closed feedback loop and the generative AI driven rule refinement contribute to continuous improvement of the system as a computing apparatus, enhancing overall robustness, reducing error rates in tone perception, and optimizing the utilization of processing resources over time.

Alternative embodiments can modify or extend particular components while remaining within the scope of the claimed invention. For example, server may use different neural network architectures, such as recurrent neural networks or convolutional sequence models, for emotion recognition, provided that such architectures map input features to emotion labels and scores. Server may implement the translation component using a modular plug-in interface that can select among multiple translation engines based on language pair, domain, or latency requirements. Terminal may run as a browser-based application rather than a native application, using web technologies and JavaScript libraries but still implementing the same data structures and communication patterns. The generative AI model may be replaced with any model capable of producing natural language rules and expressions based on prompt sentences, including models trained by different machine learning paradigms, as long as the server constructs prompt sentences and extracts rules from responses according to the described mechanisms.

By defining specific data structures, control parameters, and processing flows, and by coupling emotion-aware translation with structured feedback and generative AI rule extraction, the embodiments provide a concrete improvement to computer technology. The system modifies the manner in which computers perform translation and tone adjustment operations by incorporating non-conventional processing sequences and by optimizing neural network inference and rule application across heterogeneous hardware.

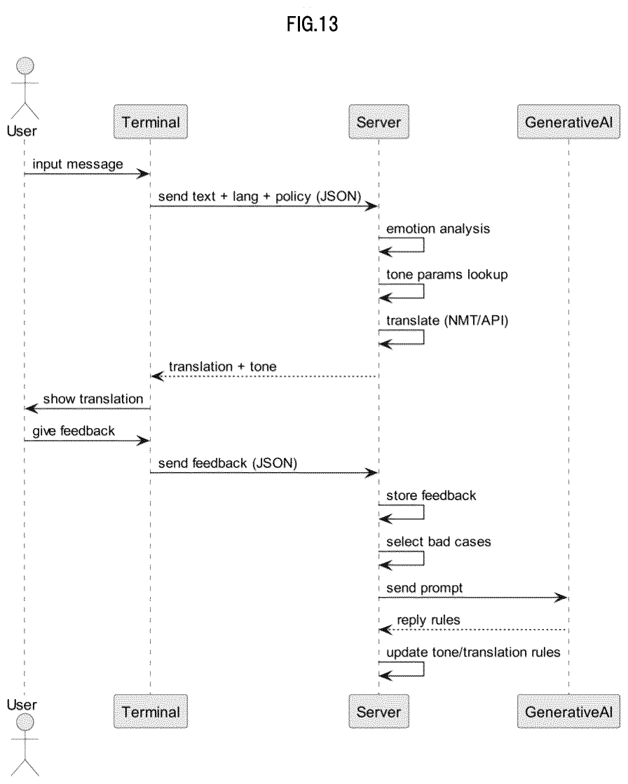

The following describes the processing flow using FIG. 13.

### Step 1:

User operates the terminal to input a message in a natural language.

User types characters on a software keyboard, speaks into a microphone, or writes on a touch panel.

Input: raw key events, audio waveforms, or pen stroke coordinates.

Output: human-intended natural language content to be captured by the terminal.

### Step 2:

Terminal acquires the raw input and converts it into a normalized UTF-8 text string.

Terminal reads key events from the OS input subsystem and concatenates them into a character sequence, or buffers audio samples from the microphone and sends the samples to a speech recognition service, or groups touch coordinates into strokes and sends the strokes to a handwriting recognition library. Terminal receives recognized text from the respective service or library and converts it to UTF-8 encoding.

Input: low-level input data (key events, PCM audio samples, stroke coordinate sequences).

Output: normalized message text as a UTF-8 string stored in a message buffer.

### Step 3:

Terminal stores the normalized message text and associates it with a message identifier.

Terminal generates a unique identifier using a counter or UUID generator and creates a record mapping the identifier to the message text in memory or local storage.

Input: UTF-8 message text from Step 2.

Output: a stored message record composed of {message_id, message_text}.

### Step 4:

User configures a target language and an emotion reflection policy on the terminal.

User selects options on a settings screen, such as “English” for target language and “Business mild tone” for emotion reflection, by manipulating dropdown lists, radio buttons, or toggles.

Input: user selection actions on the user interface.

Output: logical choices corresponding to a target language and an emotion policy.

### Step 5:

Terminal maps the user's selections to internal codes and saves them in configuration storage.

Terminal converts the language name to a language code (e.g., “en”) and the policy label to a policy code (e.g., “BUSINESS_MILD”), and writes these codes into a key-value store provided by the operating system.

Input: logical choices from Step 4.

Output: stored configuration entries {target_language_code, emotion_policy_code}.

### Step 6:

Terminal constructs a structured request object that combines message data with configuration data.

Terminal reads the message record and the stored configuration codes, then assembles a data object containing the message text, target language code, emotion policy code, and optionally an input mode flag.

Input: {message_id, message_text} from Step 3 and {target_language_code, emotion_policy_code} from Step 5.

Output: an in-memory structured request object containing all parameters required for translation.

### Step 7:

Terminal serializes the request object to JSON and transmits it to the server via an encrypted channel.

Terminal uses a JSON library to convert the request object into a JSON string and uses an HTTP client to send an HTTPS POST request to a server endpoint, setting appropriate headers and attaching the JSON string as the body.

Input: structured request object from Step 6.

Output: an HTTPS request containing the JSON payload delivered to the server.

### Step 8:

Server receives the HTTPS request and parses the JSON payload.

Server's web framework routes the request to a handler, obtains the body string, and calls a JSON parser to convert the string into a server-side data structure. Server extracts fields for message text, target language code, and emotion policy code, and stores them in local variables.

Input: JSON request body received over HTTPS.

Output: parsed request data {input_text, target_lang, emotion_policy} stored in server memory.

### Step 9:

Server tokenizes the input text and prepares tensors for emotion recognition.

Server applies a tokenizer to split the text into subword tokens and map each token to an integer ID. Server pads or truncates the list of IDs to a fixed length and allocates a tensor in host memory, then transfers the tensor to GPU memory if available.

Input: input_text from Step 8.

Output: tokenized and padded tensor representing the message text, ready for model inference.

### Step 10:

Server performs emotion recognition using a neural network model and computes emotion scores.

Server runs a forward pass through an emotion classification model implemented in a machine learning framework, generating logits for each predefined emotion class. Server applies a softmax operation to the logits to obtain a probability distribution over emotion labels.

Input: token tensor from Step 9.

Output: emotion probabilities for each class and a selected emotion label with maximum probability.

### Step 11:

Server optionally processes audio features and fuses them with text-based emotion scores.

Server, when audio data or features are present, passes them through an audio emotion model and obtains another set of class probabilities. Server computes a weighted sum of the text and audio probability vectors and normalizes the result to obtain fused scores, then selects the label with the highest fused score.

Input: text-based emotion probabilities from Step 10 and optional audio-based probabilities.

Output: fused emotion_scores and a final_emotion label.

### Step 12:

Server determines tone control parameters by consulting a rule table.

Server uses the final_emotion label and the emotion_policy code as keys to search a preloaded rule table. Server retrieves a corresponding tone configuration record that specifies politeness level, aggressiveness mitigation factor, and colloquial expression allowance, and stores this configuration as tone_params.

Input: final_emotion label and emotion_policy from Step 8 or Step 11.

Output: tone_params describing tone control settings for subsequent translation.

### Step 13:

Server prepares translation input by encoding tone information as control tokens.

Server constructs a sequence of symbolic control tokens that encode the source language, target language, and tone parameters, and concatenates this control sequence with the tokenized source text. Server converts the combined sequence into encoder input tensors.

Input: input_text from Step 8, target_lang from Step 8, and tone_params from Step 12.

Output: encoder input tensor that includes both content tokens and tone control tokens.

### Step 14:

Server runs a neural machine translation model to generate a tone-adjusted translation.

Server executes an encoder-decoder transformer model on the prepared tensor, using beam search at the decoder to maintain multiple hypotheses. Server iteratively computes next-token probabilities, extends hypotheses, and finally selects the highest-scoring token sequence as the translation output. Server detokenizes the sequence into a UTF-8 string.

Input: encoder input tensor from Step 13.

Output: translated_text in the target language, adjusted according to tone_params.

### Step 15:

Server optionally applies rule-based post-processing to further refine tone.

Server scans the translated_text for specific lexemes or phrases that match entries in a tone adjustment dictionary. Server replaces overly strong or informal expressions with softened or more formal alternatives defined by substitution rules derived from previous learning cycles.

Input: translated_text from Step 14 and tone adjustment dictionary.

Output: post-processed translated_text with refined tone characteristics.

### Step 16:

Server assembles response data including the translation and tone information.

Server constructs a response object containing translated_text, final_emotion, emotion_scores, and tone_params, and serializes this object into JSON format.

Input: translated_text from Step 14 or Step 15, final_emotion and emotion_scores from Step 11, and tone_params from Step 12.

Output: JSON response body ready to be transmitted back to the terminal.

### Step 17:

Server transmits the JSON response to the terminal over the encrypted channel.

Server sends an HTTP response with status code 200 and the JSON body over the existing HTTPS connection to the terminal.

Input: JSON response body from Step 16.

Output: HTTP response message arriving at the terminal.

### Step 18:

Terminal receives the response, parses the JSON, and extracts relevant fields.

Terminal reads the HTTP response body, invokes a JSON parser to convert the body into an object, and retrieves translated_text, final_emotion, and tone_params from the object.

Input: HTTP response body received over HTTPS.

Output: in-memory representation of the translation and metadata on the terminal.

### Step 19:

Terminal displays the translated text and related indicators to the user.

Terminal renders translated_text in a message area on the display, and optionally shows an icon or color that corresponds to final_emotion or tone settings. Terminal updates any status indicators to signal that the translation is ready.

Input: translated_text and final_emotion from Step 18.

Output: visual display of the translation and tone indicators to the user.

Step 20: User reviews the translation and evaluates its meaning accuracy and tone appropriateness.

User reads the displayed translated_text and, based on their understanding and context, decides whether the translation correctly conveys meaning and tone.

Input: on-screen translation and user's subjective judgment.

Output: intended evaluation actions that will be input to the terminal.

### Step 21:

Terminal collects structured feedback input from the user.

Terminal provides sliders, checkboxes, and text fields for feedback. User adjusts values and enters comments, and Terminal converts these interactions into numerical scores and textual comments.

Input: user manipulation of feedback controls and entered text.

Output: a feedback object containing meaning_score, tone_score, labels (e.g., “too_harsh”), and a comment string.

### Step 22:

Terminal associates feedback with the corresponding message and translation identifiers.

Terminal attaches message_id and translation_id to the feedback object, thereby linking the feedback to the specific translation instance.

Input: feedback object from Step 21 and stored identifiers.

Output: linked feedback record {message_id, translation_id, evaluation data}.

### Step 23:

Terminal serializes the feedback record into JSON and sends it to the server.

Terminal uses a JSON library to encode the feedback record and posts it to a feedback endpoint on the server using HTTPS.

Input: feedback record from Step 22.

Output: HTTPS request containing feedback JSON delivered to the server.

### Step 24:

Server receives the feedback JSON, parses it, and stores it in a database.

Server converts the JSON into a server-side object and extracts message id, translation_id, scores, labels, and comments. Server inserts a new row or document into a feedback table or collection in a database, indexing key fields for later retrieval.

Input: feedback JSON from Step 23.

Output: persistent feedback entry stored in the database.

### Step 25:

Server selects low-rated feedback records for analysis and improvement.

Server executes a query on the database to find records with tone_score below a predefined threshold or containing specific labels such as “too_harsh.” Server obtains the associated message and translation data via joins or linked collections.

Input: stored feedback entries and database query parameters.

Output: a set of problematic cases {original message, translation, emotion label, user scores, comments}.

### Step 26:

Server constructs a prompt sentence for a generative AI model based on selected cases.

Server inserts the original message, translation, emotion label, and feedback values into a textual template that describes the task to the generative AI model. Server concatenates template strings and data fields to form a coherent prompt sentence.

Input: problematic case data from Step 25.

Output: prompt_sentence strings ready to be submitted to a generative AI model.

### Step 27:

Server sends the prompt sentence to a generative AI model and receives a response.

Server calls an external or internal generative AI service via an API, providing the prompt sentence as input and specifying parameters such as temperature and maximum tokens. Server receives the generated response text containing candidate expressions and rule proposals.

Input: prompt_sentence from Step 26.

Output: response text from the generative AI model describing alternative phrasings and tone control suggestions.

### Step 28:

Server extracts structured rules and candidate expressions from the generative AI response. Server applies parsing logic, such as pattern matching and regular expressions, to identify phrase pairs, conditional statements, and mapping entries in the response text. Server organizes these into structured substitution rules and tone control rules associated with particular emotion and policy combinations.

Input: response text from Step 27.

Output: structured data representing substitution rules and tone control rule proposals.

### Step 29:

Server updates translation rules and tone control parameters based on the extracted rules. Server merges new rules with existing rule tables, resolving conflicts by precedence or administrator preference. Server updates phrase substitution dictionaries and tone control mapping tables, and refreshes in-memory caches so that subsequent translations immediately reflect the updated rules.

Input: structured rules from Step 28 and existing rule tables.

Output: updated translation rule sets and tone control configurations applied to future translation processing.

### Step 30:

Server optionally adjusts model parameters or decoding behavior according to aggregated feedback statistics.

Server computes statistics from feedback entries, such as the frequency of “too_harsh” evaluations for certain emotion-policy pairs, and applies an update logic that modifies aggressiveness mitigation factors or politeness levels numerically. Server may adjust weighting parameters used during decoding or logit modification, thus systematically shifting output distributions toward user-preferred tones.

Input: aggregated feedback statistics and current tone_params configuration.

Output: refined tone control parameters and, where applicable, adjusted model decoding behavior that improve tone accuracy in subsequent translations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional multilingual communication systems typically perform a one-shot machine translation from an input message to a target language and immediately transmit the translated text or synthesized speech. Such systems suffer from several technical limitations.

First, conventional architectures treat speech recognition, translation, and speech synthesis as largely independent modules without a unified control loop or shared adaptation mechanism. As a result, the systems cannot effectively adapt their internal models or parameters based on user feedback or real-world conversational context, which leads to persistent errors in emotion recognition, inappropriate tone selection, and inconsistent translations of domain-specific terms and frequent expressions.

Second, conventional systems generally do not integrate multimodal emotion estimation from both audio and text features into the translation and speech synthesis pipeline. Even where sentiment analysis is applied, it is often implemented as a peripheral function that does not directly influence translation phrasing, generative language modeling, or speech output parameters. This separation causes the system to output target-language messages in a neutral or mismatched tone, regardless of the speaker's actual emotional state, which in turn degrades the effectiveness of spoken interaction and increases cognitive load on the user.

Third, existing systems that invoke generative artificial intelligence models usually send simple prompts that do not structurally incorporate conversation history, emotion states, user attributes, or translation-history constraints. The prompt design is typically static and handcrafted, and it is not updated systematically based on objective feedback data. Consequently, the generative models may produce outputs that are stylistically inconsistent, emotionally inappropriate, or terminologically unstable. This leads to inefficiencies in computing resources, as the models are repeatedly invoked without benefiting from accumulated evidence of which outputs and prompt patterns perform well in particular conditions.

Fourth, conventional feedback mechanisms—if present—are usually limited to logging user satisfaction at the user-interface layer, without being fed back into the underlying machine learning models or prompt templates in a structured way. There is no integrated feedback learning loop that uses evaluation signals to rebuild training sets, retrain emotion classifiers, refine translation behavior, or re-generate prompt templates for generative models. As a result, the system cannot self-optimize over time, and its computational behavior remains static, even in the presence of rich conversational and feedback data.

Accordingly, there is a need for a computer-implemented system that technically improves the way processors coordinate speech recognition, translation, multimodal emotion estimation, generative AI prompting, and speech synthesis, and that uses structured feedback data to automatically update model parameters and prompt templates. Such a system should provide an architecture in which emotion-aware generative processing and translation-history-aware consistency control are integrated into a feedback learning loop, thereby improving the performance, robustness, and adaptability of the underlying computing components, not merely the subjective user experience.

The specific processing by the specific processing unit 290 of the data processing device 12 in Application Example 2 is realized by the following means.

The present invention provides a server comprising a processor configured to execute an integrated sequence of operations including: receiving user messages as audio signals or character strings together with associated attribute information; applying acoustic signal processing algorithms to reduce noise and echo and to generate processed audio signals; executing automatic speech recognition on the processed audio signals to obtain original-language character data; generating translation-result character data by applying a machine translation algorithm to the original-language character data while enforcing terminology consistency based on translation history information; extracting acoustic and linguistic feature information from at least one of the processed audio signals and the original-language character data; estimating an emotion state and an emotion intensity by inputting the feature information into an emotion classification model; constructing, in accordance with the translation-result character data, the estimated emotion state, and conversational context information, a prompt sentence that instructs a generative artificial intelligence model regarding output content, writing style, tone, and constraints; inputting the prompt sentence to the generative artificial intelligence model to obtain revised target-language character data adapted to the emotion state; determining audio output parameters for speech synthesis based on the revised target-language character data, recipient auditory characteristics, preference information, and the emotion state; performing speech synthesis by using the revised target-language character data and outputting synthesized speech adjusted in accordance with the audio output parameters; acquiring evaluation information from users regarding at least one of the revised target-language character data, the synthesized speech, and the estimated emotion state; and updating at least one of learning data sets or control parameters of the machine translation algorithm, the emotion classification model, and the generative artificial intelligence model based on the evaluation information and conversation history, including generating and revising prompt sentence templates stored in a dialog strategy table by re-invoking the generative artificial intelligence model with meta-level prompt sentences derived from aggregated feedback. This enables a technical improvement in the operation of the computer system by creating a closed feedback loop in which multimodal emotion estimation, translation consistency control, and prompt-driven generative language processing are jointly optimized, thereby adaptively refining model behaviors and prompt structures based on structured evaluation signals and historical interaction data, and thus enhancing the accuracy, robustness, and computational efficiency of emotion-aware multilingual communication processing.

The term “processor” refers to a hardware information processing unit, such as a central processing unit or a programmable logic device, or a logical aggregation of such units, that executes stored instructions to perform the functions described in connection with the present system.

The term “input unit” refers to a hardware and software combination that receives data from a user or an external device, including but not limited to a microphone, a touch screen, a keyboard, or a graphical user interface component, and outputs corresponding digital information to the processor.

The term “audio signal” refers to a time-varying electrical or digital representation of sound that is obtained from an acoustic sensor, such as a microphone, and that is processable by the processor for operations including noise reduction, speech recognition, and emotion estimation.

The term “character string” refers to a sequence of symbols representing text in a natural language, encoded in a digital format, and processable by the processor for operations including translation, emotion analysis, and generation of output messages.

The term “attribute information” refers to metadata associated with an input message, including at least a speaker type, a language type, and time information, and optionally other contextual attributes such as recipient identity, conversation identifier, or situation type.

The term “speaker type” refers to information indicating a classification of the message originator, such as a caregiver, a care receiver, or another category of user, and is used by the processor to adjust processing and output behaviors.

The term “language type” refers to information specifying a natural language associated with a message, including a source language or a target language, and may be represented by a language code or an equivalent identifier.

The term “time information” refers to data that indicates a temporal aspect of a message, such as a timestamp or time interval, and is used to correlate input messages with conversation history and evaluation information.

The term “acoustic signal processing algorithm” refers to a sequence of computational operations applied to an audio signal to modify or analyze its characteristics, including noise suppression, reverberation suppression, echo cancellation, and optionally beamforming and level normalization.

The term “processed audio signal” refers to an audio signal that has been subjected to at least one acoustic signal processing algorithm to improve its quality for subsequent analysis or recognition.

The term “automatic speech recognition” refers to a computational process that converts an audio signal representing spoken language into a corresponding character string in a natural language using statistical or machine learning models.

The term “original-language character data” refers to a character string in a source natural language that represents the content of a user's speech or text input and is generated by automatic speech recognition or directly received from an input unit.

The term “machine translation algorithm” refers to a computational procedure that transforms a character string in a source natural language into a character string in a target natural language using rule-based, statistical, neural, or hybrid modeling techniques.

The term “target-language character data” refers to a character string in a natural language different from the source language, generated by applying a machine translation algorithm to original-language character data.

The term “translation-result character data” refers to target-language character data that has optionally been corrected or adjusted based on translation history information or other constraints so as to provide a finalized translation output.

The term “translation history information” refers to stored data representing associations between previously processed source-language texts and their approved target-language translations, including information about domain-specific terms, frequent expressions, and contextual attributes.

The term “domain-specific term” refers to a word or phrase that is used primarily in a particular technical, professional, or specialized field and that often requires a consistent or standardized translation across messages.

The term “frequent expression” refers to a phrase or sentence that appears repeatedly in the operation context of the system and for which consistent translation and tone are desirable to ensure stable communication.

The term “acoustic feature information” refers to numerical descriptors derived from an audio signal, such as pitch, energy, spectral characteristics, and temporal features, which are used as input to emotion estimation or other classification models.

The term “linguistic feature information” refers to numerical or symbolic descriptors derived from a character string, such as token embeddings, part-of-speech tags, or syntactic patterns, which are used as input to emotion estimation or other language processing models.

The term “emotion classification model” refers to a machine learning model that receives acoustic feature information and/or linguistic feature information as input and outputs an estimated emotion state and, optionally, an intensity measure for one or more emotion categories.

The term “emotion state” refers to information indicating a psychological condition of a speaker, such as anxiety, anger, sadness, joy, or neutrality, and may include a set of intensity values corresponding to different emotion categories.

The term “emotion intensity” refers to a quantitative measure that indicates the strength or degree of a particular emotion state for a given input message.

The term “conversational context information” refers to data describing situational aspects of an interaction, including but not limited to an activity type, a dialog stage, participant roles, or environment conditions, and is used by the processor to tailor prompt sentences and output messages.

The term “prompt sentence” refers to a character string provided as input to a generative artificial intelligence model that specifies desired output content, style, tone, constraints, and contextual information so as to guide generation of revised text.

The term “generative artificial intelligence model” refers to a machine learning model that, given an input such as a prompt sentence and optional context, produces new text data by probabilistically predicting sequences of symbols in a natural language.

The term “revised target-language character data” refers to target-language text that is generated or modified by the generative artificial intelligence model based on a prompt sentence, such that the text is adapted to an estimated emotion state, conversational context, and specified constraints.

The term “auditory characteristics” refers to information describing a recipient's hearing abilities, such as sensitivity in specific frequency ranges, presence of hearing impairment, or usage of hearing assistance devices, and is used to determine appropriate audio output parameters.

The term “preference information” refers to user-specific settings indicating desired properties of audio or textual output, such as preferred speaking rate, volume level, voice type, or formality level.

The term “audio output parameters” refers to control values supplied to a speech synthesis engine, including at least a sound volume, a speaking rate, and a pitch, and optionally additional parameters such as voice type or prosody pattern.

The term “speech synthesis processing” refers to a computational process that converts text data into an audio signal representing spoken language using a text-to-speech engine or equivalent technology.

The term “synthesized speech” refers to an audio signal generated by speech synthesis processing that acoustically represents a given character string in a specified language.

The term “evaluation information” refers to data received from a user that indicates a qualitative or quantitative assessment of system outputs, including at least assessments of translation quality, speech naturalness, and emotion estimation correctness, and may be represented as ratings, categorical choices, or free-text comments.

The term “conversation history” refers to data representing a collection of past interactions processed by the system, including input messages, translation results, emotion states, prompt sentences, synthesized speech parameters, and associated timestamps.

The term “feedback processing” refers to operations in which evaluation information and conversation history are analyzed and used to adjust or retrain models, update control parameters, or modify prompt sentence templates.

The term “learning data set” refers to a structured collection of labeled examples comprising input data and corresponding target outputs that is used to train or retrain a machine learning model such as an emotion classification model or a translation model.

The term “control parameter” refers to a value that configures the behavior of an algorithm or a machine learning model, such as a weight, threshold, hyperparameter, or rule coefficient, and that can be adjusted to improve system performance.

The term “meta-level prompt sentence” refers to a prompt sentence provided to a generative artificial intelligence model that describes how to design or improve other prompt sentence templates or strategies, rather than requesting direct end-user content.

The term “prompt sentence template” refers to a predefined pattern for constructing a prompt sentence, including placeholders for variable elements such as emotion state, language pair, and situation type, and is used to generate concrete prompt sentences for the generative artificial intelligence model.

The term “dialog strategy table” refers to a data structure that stores multiple prompt sentence templates and associated conditions, such as applicable emotion states, situation types, or language pairs, and that is referenced by the processor when selecting or combining templates for prompt construction.

The term “recipient” refers to an entity, such as a human user or an external device, that receives translation-result character data, revised target-language character data, or synthesized speech output produced by the system.

In one or more embodiments, the system is implemented as a distributed computer system including at least one server and at least one terminal communicating over a network.

The server includes at least one processor, a memory, and a network interface operating under control of a server operating system such as a general-purpose server OS. The terminal includes at least one processor, a memory, a microphone, a speaker, a display, and a wireless communication unit operating under control of a mobile operating system such as a general-purpose mobile OS.

The terminal executes an application program that implements a multilingual communication client. The terminal uses a graphical user interface framework of the mobile operating system to render screens, including a login screen, a conversation screen, and a feedback screen. The terminal uses a network communication library to send and receive structured messages, for example JSON messages, via a secure transport protocol such as HTTPS.

The terminal uses an audio input API of the mobile operating system to acquire audio signals from the microphone. The terminal uses an audio processing library, such as a library based on an acoustic processing framework, to apply noise suppression, reverberation suppression, and echo cancellation to the raw audio signals. The terminal generates a processed audio signal in a linear PCM or compressed digital format. The terminal may use a library implementing beamforming when a multi-microphone configuration is available, thereby forming a directional reception pattern.

The terminal uses a speech recognition client software development kit (SDK), such as a cloud speech-to-text client SDK, to send the processed audio signal to an automatic speech recognition (ASR) service or to execute an on-device ASR model. The ASR service or model uses an acoustic model and a language model, which may be implemented as a deep neural network such as a recurrent neural network or a transformer-based network trained on speech-text pairs. The ASR model converts the processed audio signal into a sequence of linguistic tokens and outputs original-language character data. The terminal receives the character data and stores it, together with attribute information including a speaker type, a language type, and time information, in a local data structure.

The server receives, via the network interface, messages from the terminal that include original-language character data and, in some embodiments, processed audio signals. The server stores these messages in a conversation log data structure in the memory, where each log record includes an utterance identifier, speaker type, language identifiers, time information, original-language character data, and a reference to the corresponding audio data.

The server executes a translation module implemented as a software component that interacts with a machine translation engine. The server uses an external machine translation API or an in-house neural machine translation model implemented with a machine learning framework such as a neural network library. The neural machine translation model may be a sequence-to-sequence model with an encoder-decoder architecture and attention mechanism, implemented by a transformer network trained on large bilingual corpora. The server inputs original-language character data and language identifiers to the translation module and receives target-language character data as a translation result.

The server stores translation history information in a translation history database. The server records, for each processed utterance, the original-language character data, the target-language character data, a domain label, and usage frequency. The server uses string matching algorithms and semantic similarity measures (for example, cosine similarity over sentence embeddings generated by a language model) to identify domain-specific terms and frequent expressions. When the server processes new original-language character data, the server searches the translation history database for matching or similar source segments. The server replaces or adjusts parts of the raw translation result with previously approved translations for domain-specific terms and frequent expressions. This translation history mechanism reduces inconsistent translations, improves computational efficiency by reducing repeated evaluation of alternative forms, and provides more stable data for downstream processing.

The server executes an emotion estimation module that combines acoustic feature extraction and linguistic feature extraction. The server loads the processed audio signal into an audio feature extraction library, such as a library providing Mel-frequency cepstral coefficients, pitch contour, energy contour, spectral centroid, and temporal features including speech rate and pause durations. The server aggregates these features into a fixed-length acoustic feature vector per utterance. The server also uses a natural language processing library such as a transformer-based embedding model to convert the original-language character data into a linguistic feature vector, for example by taking the embedding of a dedicated classification token or by pooling token embeddings.

The server inputs the acoustic feature vector and the linguistic feature vector into an emotion classification model. In one embodiment, the emotion classification model includes two sub-networks: an acoustic sub-network and a text sub-network, each implemented as a neural network (for example, a multi-layer perceptron for acoustic features and a fine-tuned transformer classifier for text features), and a fusion layer that combines the outputs from the sub-networks. The fusion layer may be implemented as a fully connected neural layer that outputs a probability distribution over emotion categories such as anxiety, anger, sadness, joy, and neutrality. The server uses a softmax function to obtain normalized probabilities, and the server may compute emotion intensities as continuous scores derived from the logits or as expected values over an ordered set of intensity levels.

The server trains the emotion classification model using supervised learning. The server constructs a learning data set containing pairs of feature vectors and labeled emotion states. During training, the server uses a loss function such as cross-entropy between predicted emotion probabilities and ground-truth labels. The server updates trainable weights of the neural networks via gradient descent or a variant such as Adam optimization. The server may perform data augmentation by adding noise to audio samples, time-stretching speech, or augmenting text data through synonym substitution, thereby improving robustness and reducing overfitting.

The server executes a generative AI integration module that constructs a prompt sentence for a generative AI model. The server uses the translation-result character data, the estimated emotion state, and conversational context information stored in the conversation log. The server uses a dialog strategy table that stores prompt sentence templates indexed by emotion category, situation type, and language pair. Each template includes fixed text segments and variable placeholders for inserting the original message, the base translation, and explicit instructions regarding tone, length, and semantic constraints.

The server selects a prompt sentence template from the dialog strategy table based on the emotion category and the situation type. For example, when the emotion category is anxiety and the situation type corresponds to a medical measurement, the server selects a template specialized for reassuring explanations. The server fills the placeholders with actual values, such as the original-language message and the translation-result character data, to generate a concrete prompt sentence.

The server, for example, generates a prompt sentence in text form as follows: “The caregiver in a nursing facility is speaking to an elderly resident who feels anxious. Translate and rewrite the following message into the resident's native language, using a calm and reassuring tone. Use short, simple expressions that older adults can easily understand, and include a phrase equivalent to ‘please don't worry’. Original message: ‘Now we will measure your blood pressure. It will be finished soon, so please don't worry.’ Machine translation result (for reference): <base translation>. Correct this translation to be more natural, gentle, and reassuring.”

The server uses an API client library to send the prompt sentence to a generative AI model, which in one embodiment is a large-scale language model with a transformer architecture trained on massive text corpora. The server specifies parameters such as model identifier, temperature, and maximum token count. The generative AI model internally performs iterative token prediction using masked self-attention and feed-forward layers, drawing from its learned parameters. The server receives the generated text as revised target-language character data.

The server processes the model's output to remove extraneous descriptive text, leaving only the portion that represents the final message in the target language. The server stores the revised target-language character data in the conversation log and associates it with the emotion state, the prompt sentence used, and the corresponding original-language data. The server executes an audio parameter determination module. The server retrieves from a recipient profile database the auditory characteristics and preference information for the intended recipient. The server may read fields representing preferred speaking rate, recommended volume range, preferred pitch, and sensitivity at specific frequency bands. The server uses rule-based logic to derive audio output parameters from the profile and the emotion state. For example, when the emotion state indicates high anxiety, the server reduces the speaking rate by a fixed percentage, selects a softer pitch profile, and increases volume within a profile-specific safe range. When the profile indicates high-frequency hearing loss, the server may adjust a spectral emphasis parameter for the speech synthesis engine.

The terminal receives the revised target-language character data and the audio output parameters. The terminal uses a text-to-speech (TTS) engine provided by the mobile operating system or a dedicated speech synthesis library. The TTS engine may implement a neural network-based synthesizer such as a sequence-to-sequence model with attention or a neural vocoder. The terminal sets the speaking rate, pitch, and volume parameters via the TTS API. The terminal converts the revised target-language character data into synthesized speech and outputs the audio through the speaker hardware. The terminal simultaneously displays the revised text on the display, using large font sizes and high contrast to facilitate visual comprehension.

The user, as a recipient, listens to the synthesized speech and, if desired, reads the displayed text. The user can interact with the terminal via touch controls to replay the synthesized speech or to adjust volume within allowed limits.

The server executes a feedback collection and learning module. The terminal provides, on the display, interface elements that allow the user to submit evaluation information regarding the translation quality, the appropriateness of the emotion state estimation, and the naturalness and intelligibility of the synthesized speech. The terminal encodes selections such as “translation appropriate”, “translation unnatural”, “emotion incorrect”, and optional free-text comments into structured evaluation records. The terminal sends these records to the server via HTTPS.

The server receives the evaluation records and stores them in a feedback database, linking each record to conversation log entries via unique identifiers. The server periodically executes analytics jobs that aggregate evaluation statistics according to emotion category, language pair, situation type, prompt sentence template, and recipient profile attributes. The server identifies combinations of conditions that yield low evaluation scores, such as specific prompt sentence templates used in particular emotion states.

The server constructs new learning data sets for retraining the emotion classification model by selecting audio and text samples associated with evaluations indicating misclassification. The server uses these samples with corrected emotion labels to update the model's weights via additional training epochs. The server recalculates gradients using the loss function and updates parameters in the neural networks. This targeted retraining reduces systematic errors in emotion estimation and improves model accuracy over time.

The server also uses the generative AI model at a meta level to redesign prompt sentence templates. The server constructs meta-level prompt sentences that describe empirical findings from aggregated feedback, such as: “From previous conversation logs and user feedback, the following facts are known: (1) For anxious residents, messages that contain an expression equivalent to ‘you will be okay’ receive higher satisfaction. (2) For angry residents, adding a brief explanation after ‘I am sorry’ is effective. Based on these facts, design new prompt templates for multilingual messages in a care facility. For each emotion state (anxiety, anger, sadness), provide three example messages in a base language and their translations into two other languages. All examples must be simple, concise, and reassuring for older adults.”

The server sends such meta-level prompt sentences to the generative AI model, receives proposed prompt sentence templates and example messages, and parses them into structured entries. The server updates the dialog strategy table by inserting new or modified templates and deprecating low-performing ones. This process changes not only the textual outputs but also the internal control logic by which prompt sentences are assembled, thereby improving computational efficiency and output quality.

The system thus realizes a closed-loop optimization mechanism: the server uses real-time multimodal emotion estimation and translation history to control the behavior of the generative AI model and the speech synthesizer; the terminal executes front-end capture, rendering, and audio playback with parameters computed by the server; the user supplies evaluation information; and the server uses that information to retrain models and regenerate prompt sentence templates. This architecture improves computer technology itself by enabling the processor to allocate computation in a context-aware manner, reducing the number of iterations required to obtain acceptable translations, reducing error rates in emotion estimation, and improving bandwidth usage by reducing redundant transmission of low-quality outputs.

In one embodiment, the server partitions processing into independent microservices: a translation service, an emotion service, a generative AI integration service, and a feedback analysis service. The server uses a message queue to decouple these services, allowing parallel processing of multiple utterances and scaling across multiple processor cores or machines. This microservice architecture reduces latency for end users and increases overall throughput, providing a concrete improvement in processing speed and scalability compared to monolithic implementations.

In another embodiment, the terminal executes some or all of the ASR and TTS processing locally using on-device neural models, thereby reducing network load and response time. The server in this embodiment focuses on translation, emotion estimation, generative AI prompting, and feedback analysis. This distribution of computation reduces communication overhead and increases robustness in environments with limited network connectivity.

The technical effect arises because the server does not simply automate human translation or message rewriting; instead, the server implements non-conventional computational steps that coordinate multimodal feature extraction, neural emotion classification, translation-history-driven consistency correction, and meta-level prompt template optimization. The feedback learning loop systematically modifies model parameters and prompt sentence templates based on objective evaluation signals and data-driven rules that humans could not feasibly apply in real time across large volumes of interactions. As a result, the system reduces misclassification of emotion states, improves consistency and appropriateness of generated text, and optimizes the usage of computing and network resources, thereby improving the functioning of the computer system as a whole.

In yet another embodiment, the server uses alternative model architectures, such as convolutional neural networks for acoustic feature processing or recurrent networks for temporal aggregation, and alternative loss functions, such as focal loss, to further improve classification accuracy in imbalanced emotion data sets. The server may apply dimensionality reduction techniques or quantization to model parameters to reduce memory footprint and accelerate inference on resource-constrained hardware. These variations remain within the scope of the system, as long as the processor performs the interconnected operations of translation, multimodal emotion estimation, generative AI prompt sentence construction, emotion-adaptive text revision, speech parameter determination, and feedback-driven learning.

The terminal, the server, and the user thus cooperate to implement a system in which the processor dynamically adapts and improves translation, emotion classification, and generative text generation behaviors over time, using specific data structures, algorithms, and model training procedures that yield measurable improvements in speed, accuracy, and efficiency of multilingual, emotion-aware communication processing.

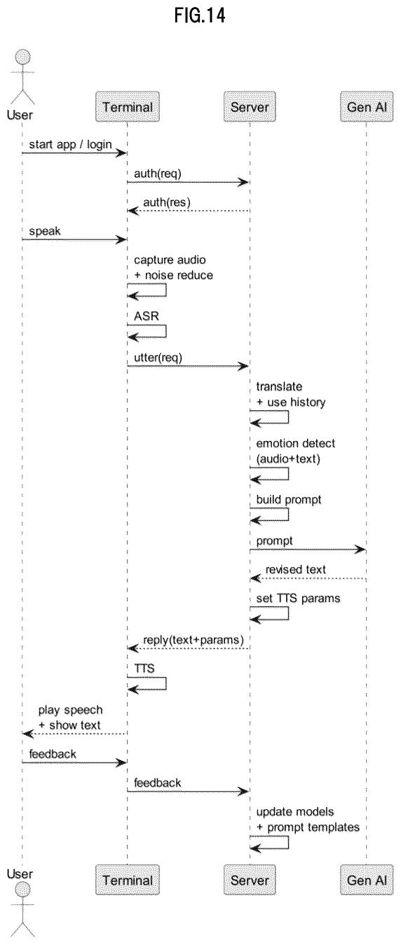

The following describes the processing flow using FIG. 14.

### Step 1:

The user operates the terminal to launch the multilingual communication application and to log in.

The terminal receives as input a user identifier and an authentication secret (for example, a password) entered via a graphical user interface, and optionally a selected recipient identifier.

The terminal performs local format validation on the entered strings (for example, checking non-empty fields and allowed character sets), constructs an authentication request object that includes the identifier, the secret, the recipient identifier, and a device identifier, and outputs this object as a JSON message.

The terminal sends the JSON message as an HTTPS request to the server using a network communication library.

### Step 2:

The server receives the authentication request as input and parses the JSON message into internal variables.

The server performs a database lookup in a user table, using the received user identifier as a key, and obtains stored authentication data and user attributes.

The server computes a hash of the received authentication secret using a key-derivation function and compares the result with the stored hash; based on this comparison, the server determines whether authentication is successful.

The server, when authentication succeeds, reads a recipient profile record from a profile table using the recipient identifier as a key, and then generates as output an access token and profile data including language preferences, auditory characteristics, and user interface preferences. The server encodes the token and the profile data into a JSON response and sends it to the terminal over HTTPS.

### Step 3:

The terminal receives the JSON response from the server as input and extracts the access token and recipient profile fields.

The terminal writes the token into a secure storage area, and stores the profile data into an in-memory structure used for later parameter decisions.

The terminal updates the screen from a login view to a conversation view, and displays the recipient's basic information using the graphical user interface framework.

The terminal outputs a ready state in which a “Talk” control and related interface elements are active for capturing messages.

### Step 4:

The user presses a “Talk” button on the terminal and speaks toward the microphone in a first language.

The terminal detects the button press event as input and calls an audio capture API to start recording raw audio samples from the microphone at a configured sampling rate and bit depth.

The terminal accumulates raw audio frames into an audio buffer while the user is speaking, and shows a recording indicator on the screen.

The terminal outputs a sequence of raw audio frames representing the spoken message.

### Step 5:

The terminal uses the raw audio frames as input to an audio processing library that implements noise suppression, reverberation suppression, and echo cancellation.

The terminal executes digital signal processing operations on successive audio frames, such as spectral subtraction and adaptive filtering, to attenuate background noise and echoes.

The terminal concatenates the processed frames and outputs a processed audio signal with reduced noise and improved speech clarity.

The terminal optionally passes the processed audio signal through a beamforming module when multiple microphones are available, further enhancing the signal from the user's direction.

### Step 6:

The terminal sends the processed audio signal as input to a speech recognition client SDK.

The terminal, in a streaming or batch mode, transmits audio chunks via the SDK to an automatic speech recognition engine and receives partial and final recognition hypotheses.

The terminal aggregates recognized tokens and converts them into a character string in the original language.

The terminal outputs original-language character data along with recognition confidence values and a language identifier.

### Step 7:

The terminal constructs an utterance message using the original-language character data and associated metadata as input.

The terminal attaches to the character data the speaker type (for example, caregiver), a source language code, a target language code, a timestamp, a conversation identifier, and optionally a reference to the processed audio signal.

The terminal serializes this structured data into a JSON or similar format and outputs it as an utterance request.

The terminal sends the utterance request to the server via HTTPS, including the previously stored access token in an authorization header.

### Step 8:

The server receives the utterance request as input and validates the access token.

The server parses the received structured data into separate variables: original-language character data, metadata, and audio data or its reference.

The server writes a new conversation log entry into a conversation table that stores the utterance identifier, the speaker type, the languages, the timestamp, and the raw input data.

The server outputs references to this stored data for use by downstream modules.

### Step 9:

The server inputs the original-language character data and the language identifiers to a translation module.

The server calls a machine translation function or an external translation service with the source text and the source and target language codes as input.

The server receives as output a preliminary target-language character string representing a base translation.

The server logs the base translation together with the original text into a temporary translation record.

### Step 10:

The server uses the original-language character data and the base translation as input to a translation consistency component.

The server queries a translation history database for prior entries whose source segments match or are similar to segments of the current original-language character data, using string matching and embedding similarity computations.

The server determines, for each detected domain-specific term or frequent expression, whether a preferred translation exists in the translation history.

The server replaces or adjusts portions of the base translation with the preferred translations and outputs a corrected translation string as translation-result character data.

### Step 11:

The server receives the processed audio signal and the original-language character data as input to an acoustic feature extractor and a text feature extractor.

The server computes acoustic features per frame (for example, pitch, energy, spectral parameters) and aggregates them into an acoustic feature vector, and computes linguistic features (for example, token embeddings and a sentence embedding) for the character data.

The server concatenates or otherwise combines these feature vectors and supplies them as input to an emotion classification model.

The server executes the model to obtain as output an estimated emotion category and a set of emotion intensity values.

### Step 12:

The server retrieves the conversation context and applicable situation type as input, based on the conversation identifier and the metadata in the conversation log.

The server reads from a dialog strategy table a set of candidate prompt sentence templates that correspond to the detected emotion category, the situation type, and the language pair.

The server selects one template according to pre-defined rules or priority weights and outputs the selected template along with the translation-result character data and the original-language character data for prompt construction.

### Step 13:

The server inputs the selected prompt sentence template, the translation-result character data, the original-language character data, the emotion category and intensity, and the situation description into a prompt construction module.

The server replaces placeholder tokens in the template with concrete text fragments, including the content of the original message, the base translation, and natural language phrases that describe the emotion state and the desired tone.

The server concatenates these fragments into a coherent prompt sentence that specifies output content, writing style, tone, and constraints for a generative AI model.

The server outputs the constructed prompt sentence as a plain text string.

### Step 14:

The server sends the prompt sentence as input to a generative AI model through an API client.

The server configures model parameters such as temperature and maximum output length and performs an HTTP request carrying the prompt sentence to a remote language model engine.

The server receives from the engine a generated text sequence in the target language, which represents a revised translation adapted to the specified emotion and constraints.

The server parses and cleans the generated text to remove any non-message parts and outputs revised target-language character data.

### Step 15:

The server logs the prompt sentence and the revised target-language character data as input into the conversation log along with the emotion state and the template identifier.

The server associates these outputs with the original utterance record and stores cross-references for later feedback analysis and model retraining.

The server outputs a combined record that includes the revised translation, emotion state, and the identifiers for the prompt template and model parameters used.

### Step 16:

The server retrieves, as input, a recipient profile that includes auditory characteristics and preference information, together with the emotion state and the revised target-language character data.

The server evaluates rule sets that map combinations of profile attributes and emotion categories to numerical audio output parameters, including speaking rate, volume level, and pitch adjustment.

The server calculates a parameter vector that satisfies profile constraints (for example, maximum safe volume) and modifies the vector according to emotion-dependent rules (for example, slower speech for high anxiety).

The server outputs the revised target-language character data along with the computed audio parameter vector in a response message to the terminal.

### Step 17:

The terminal receives the response message as input and extracts the revised target-language character data and the audio parameters.

The terminal calls a text-to-speech API with the revised text and sets the speaking rate, pitch, and volume according to the provided parameters.

The terminal instructs the TTS engine to synthesize speech and obtains an audio buffer containing synthesized speech in the target language.

The terminal outputs the synthesized speech through the speaker and simultaneously renders the revised text on the display in a readable format.

### Step 18:

The user, as a recipient, listens to the synthesized speech and, if necessary, reads the displayed text.

The user may operate controls on the terminal, such as a replay button or a volume slider, which the terminal interprets as new input events to adjust playback or to regenerate audio with different system-allowed settings.

The terminal uses these inputs to control audio playback and to manage user interface states, and outputs updated audio output and screen content accordingly.

### Step 19:

The server and the terminal jointly support reverse-direction communication by treating new audio captured from the recipient as input and applying the same chain of processing steps with reversed language roles.

The terminal records speech in the recipient's native language, processes the audio, and sends recognized original-language character data to the server.

The server translates this data into the caregiver's language, estimates emotion, constructs a prompt sentence if refinement is required, obtains revised character data, and outputs this result back to the caregiver's terminal.

The caregiver's terminal displays the translation and emotion labels and optionally synthesizes speech, thereby outputting an interpreted version of the recipient's message.

### Step 20:

The terminal presents a feedback interface to the user as input, showing the translation, the emotion label, and controls for rating and comments.

The user selects evaluation options such as correctness of translation and emotion and may enter free-form comments; the terminal collects these choices into an evaluation object.

The terminal transmits the evaluation object to the server as a structured message.

The terminal outputs an updated interface state acknowledging receipt of feedback and may clear or archive the evaluated conversation segment.

### Step 21:

The server receives evaluation objects as input and links them to corresponding conversation log records using stored identifiers.

The server aggregates these records into statistical summaries using grouping keys such as emotion category, language pair, prompt template identifier, and situation type.

The server computes performance metrics, such as error rates and mean ratings, and identifies patterns where specific templates or model settings perform poorly.

The server outputs analysis results to a feedback analysis module and stores derived indicators for subsequent model and template updates.

### Step 22:

The server uses conversation samples with associated evaluation labels as input to build retraining data sets for the emotion classification model and optionally for translation or auxiliary models.

The server extracts feature vectors and corrected target labels and organizes them into training batches.

The server performs additional training epochs on the neural model, computing gradients of a loss function with respect to model weights and updating the weights using an optimization algorithm.

The server outputs updated model parameters that reflect the new training data and deploys these parameters to the emotion estimation module.

### Step 23:

The server constructs meta-level prompt sentences as input to a generative AI model by summarizing patterns discovered in feedback analysis, such as beneficial phrasing and problematic templates.

The server sends these meta-level prompt sentences to the generative AI model to request revised or new prompt sentence templates that are tailored to specific emotion states and situations.

The server receives generated template texts, parses them into structured template entries with placeholders, and validates them against internal rules.

The server outputs updated prompt sentence templates and writes them into the dialog strategy table, thereby modifying future prompt construction behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

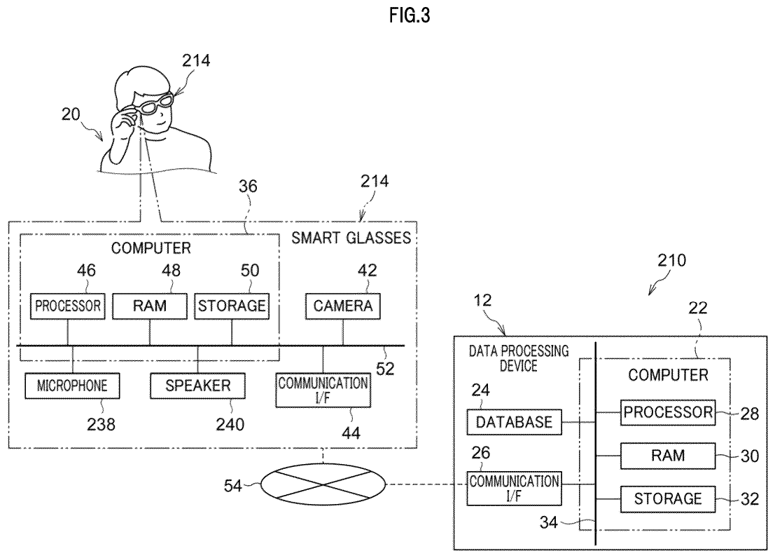

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34.

The database 24 and the communication I/F 26 are also connected to the bus 34. The communication IF 26 is connected to a network 54. Examples of the network 54 include a Wide Area Network (WAN) and/or a local area network (LAN).

The smart glasses 214 include a computer 36, a microphone 238, a speaker 240, a camera 42, and a communication IF 44. The computer 36 includes a processor 46, RAM 48, and storage 50. The processor 46, the RAM 48, and the storage 50 are connected to a bus 52. The microphone 238, the speaker 240, the camera 42, and the communication IF 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication 1F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

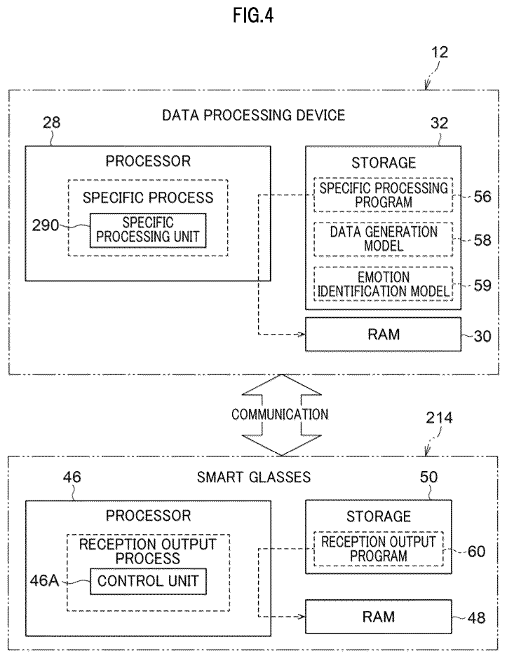

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

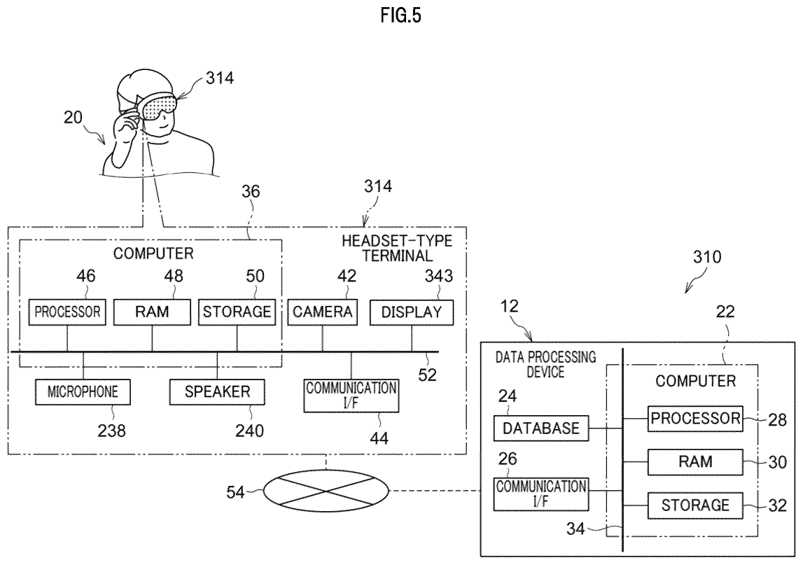

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication 1/F 44 is connected to the network 54. The communication 1/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

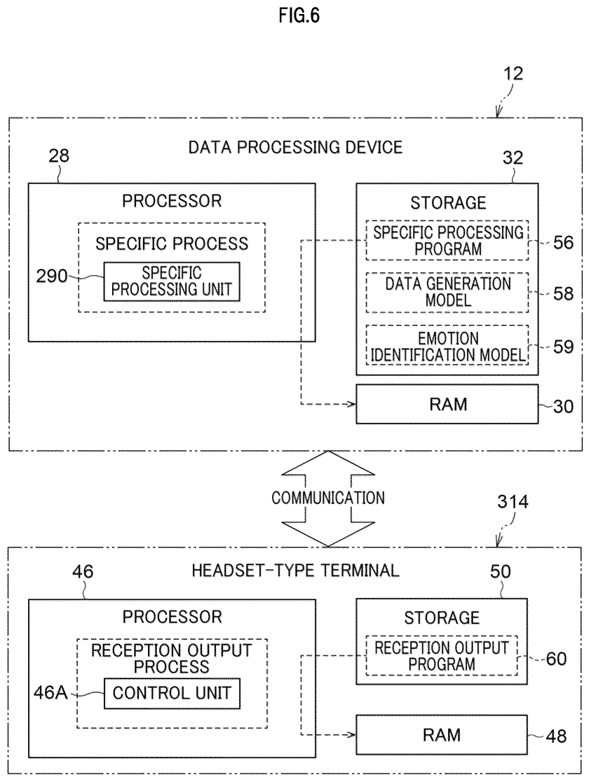

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

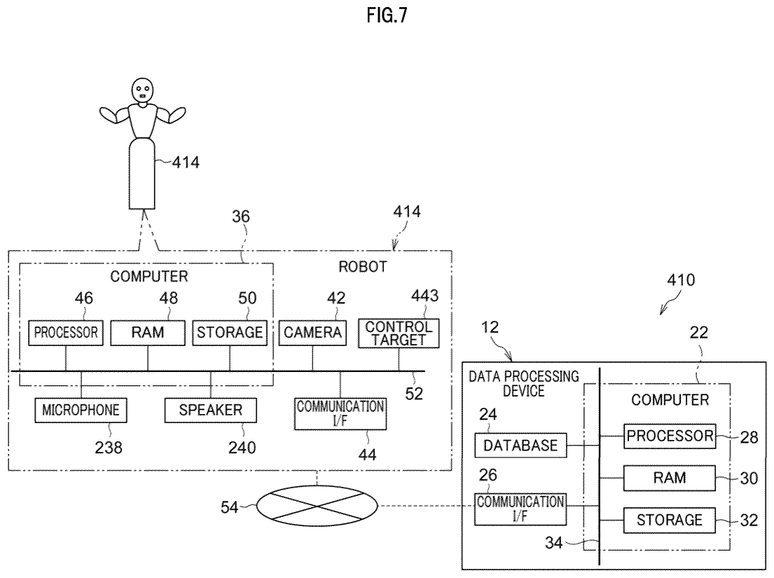

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

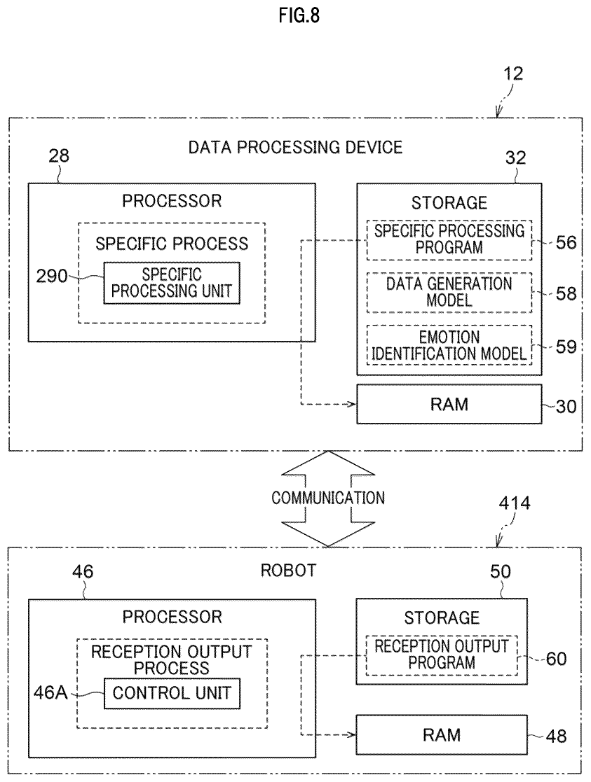

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56.

The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

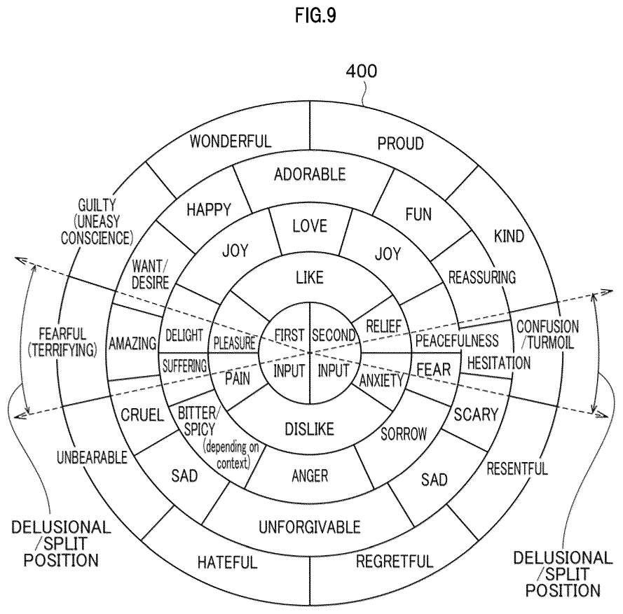

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

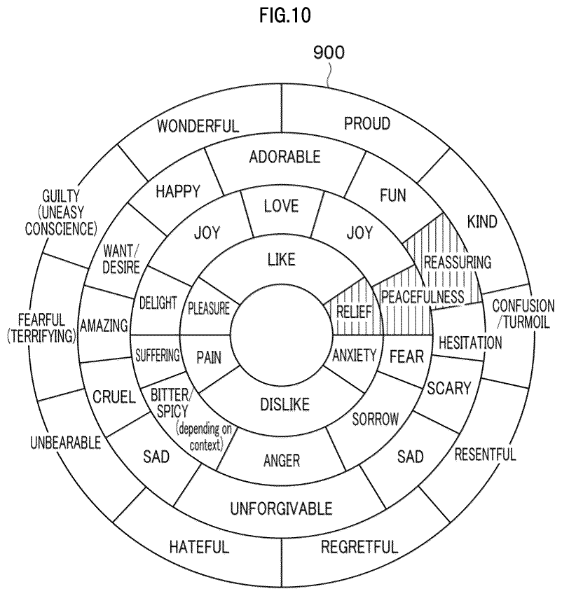

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, at a user terminal, character information, voice information, or handwriting information input by a user, and perform at least one of error correction processing, noise reduction processing, character recognition processing, and speech recognition processing on the acquired information to generate standardized message information,
transmit, from the user terminal via a communication network, first transmission information including the standardized message information and language identification information corresponding to a translation target language,
receive, at a server, the first transmission information, and execute at least one of language determination processing and translation processing based on a machine learning model on the standardized message information to generate translated message information, and perform terminology consistency processing on the translated message information based on translation history information stored in a translation history information storage unit to correct an expression of the translated message information,
transmit, from the server via the communication network, the translated message information as second transmission information to the user terminal or to another terminal, acquire, at the user terminal, setting information for selecting or changing the translation target language, provide the acquired setting information as the language identification information to a first transmission function, and change a display order of candidate languages based on a use frequency of each translation target language,
acquire, from the user terminal, evaluation information and improvement request information with respect to the translated message information, store the acquired evaluation information and improvement request information in association with the translation history information, and perform aggregation processing and analysis processing on the stored information to generate characteristic information relating to translation performance, and
automatically generate, based on the characteristic information and the translation history information, a prompt sentence to be input to a generative AI model, transmit inquiry information including the prompt sentence to a generative AI model providing apparatus, and update at least one of translation model configuration information, terminology consistency processing conditions, and translation parameters in the translation processing based on response information acquired from the generative AI model.

### (Supplementary 2)

The system according to supplementary 1,
wherein the processor is configured to
perform the noise reduction processing on a voice signal acquired by a voice acquisition function, subsequently perform the speech recognition processing on the voice signal to convert the voice signal into text information, perform the character recognition processing on handwriting trajectory information to convert the handwriting information into text information, and provide the text information as the standardized message information to the first transmission function.

### (Supplementary 3)

The system according to supplementary 1,
wherein the processor is configured to
transmit, as the second transmission information, the translated message information to a receiving-side terminal without accepting a translation result confirmation operation by a user of the user terminal, and transmit transmission result information to the user terminal so as to update a display state on the user terminal.

### Application Example 1

### (Supplementary 1)

A system comprising a processor,
wherein the processor is configured to
acquire an acoustic signal from a user and convert speech included in the acoustic signal into character information,
transmit the character information to an information processing apparatus via a communication network and receive, from the information processing apparatus, translation result information and associated control information,
generate, in the information processing apparatus, the translation result information based on the character information, translation history information corresponding to the character information, and evaluation information acquired from the user, and control translation processing so as to maintain consistency of terminology and writing style in the translation result information,
output the translation result information by performing voice synthesis processing or display processing on a terminal apparatus,
acquire evaluation information and correction text relating to the translation result information from the user and transmit the evaluation information and the correction text to the information processing apparatus,
analyze the evaluation information and the translation history information and update translation vocabulary information, translation processing conditions, and user-oriented expressions based on an analysis result,
generate a prompt sentence to be input to a generative information processing model from explanation information including the evaluation information and the analysis result, input the prompt sentence to the generative information processing model, and automatically adjust at least one of the translation processing conditions and the translation vocabulary information based on a response obtained from the generative information processing model, and control at least one of a volume, a speaking rate, and a language type used in the voice synthesis processing on the terminal apparatus in accordance with user attribute information.

### (Supplementary 2)

The system according to supplementary 1,
wherein the processor is configured to
generate the prompt sentence for the generative information processing model so as to include explanation information relating to tendencies of translation errors in multilingual dialogue in a care-support environment, adjustment policies for honorific expressions, and replacement candidates for frequently used terms, and update translation memory information,
terminology information, and control parameters used during the translation processing in the information processing apparatus based on the response output from the generative information processing model.

### (Supplementary 3)

The system according to supplementary 1,
wherein the processor is configured to
automatically start generation processing of the prompt sentence for the generative information processing model in a case where low evaluation information relating to an expression specific to a care-support use has been accumulated a predetermined number of times or more, generate a plurality of alternative expression candidates from the response obtained based on the prompt sentence, present the plurality of alternative expression candidates to the user, and reflect a selection result of the user in the translation history information and the translation vocabulary information.

### Example 2

### (Supplementary 1)

A system comprising a processor,
wherein the processor is configured to
receive, from an information processing apparatus operated by a user, a message expressed in a natural language and convert the message into a unified character string format and store the unified character string in a memory of the information processing apparatus as message data, generate, at the information processing apparatus, structured data including the message data, language designation information indicating a target language for translation, and policy information indicating an emotion reflection policy, and transmit the structured data to a server via an encrypted communication path,
execute, at the server, emotion recognition processing on the message data extracted from the structured data by applying a machine learning model to the message data to calculate an emotion label and an emotion score associated with the message data,
determine, at the server, tone control parameters including at least a politeness level, a mitigation degree of aggressive expressions, and a permissibility degree of colloquial expressions by referring to a rule table on a basis of the emotion label and the policy information,
generate, at the server, translation request parameters for a neural network based translation model or an external translation service on a basis of the tone control parameters and the language designation information, and cause the neural network based translation model or the external translation service to convert the message data into translation result data in the target language,
generate, at the server, response data including the translation result data, the emotion label, and the tone control parameters, and transmit the response data to the information processing apparatus via the encrypted communication path,
cause the information processing apparatus to display the translation result data, and acquire, from the user, feedback information including an evaluation regarding meaning accuracy of the translation result data and an evaluation regarding tone appropriateness of the translation result data and comment information, and transmit the feedback information and the comment information to the server,
store, at the server, a correspondence among the feedback information, the message data, and the translation result data in a storage device, and update at least one of a model, parameters, and translation rules used by the emotion recognition processing or translation processing on a basis of stored information so as to improve processing performance, and
generate, at the server, a prompt sentence to be input to a generative artificial intelligence model on a basis of the stored feedback information and the translation result data, transmit the prompt sentence to the generative artificial intelligence model, acquire a response including candidate expressions and tone control rule proposals from the generative artificial intelligence model, extract the candidate expressions and the tone control rule proposals from the response, and update at least one of the tone control parameters and the translation rules on a basis of the extracted candidate expressions and tone control rule proposals.

### (Supplementary 2)

The system according to supplementary 1,
wherein the processor is configured to
select, from the stored feedback information, a record in which the evaluation regarding tone appropriateness is lower than a predetermined value, generate the prompt sentence by inserting an original message, the translation result data, the emotion label, and a user comment contained in the selected record into a predetermined template, transmit the prompt sentence to the generative artificial intelligence model, and, from a response of the generative artificial intelligence model, extract at least one of a substitution rule for replacing an expression with a mitigated expression or a polite expression and an assignment rule defining a mapping between a combination of an emotion label and an emotion reflection policy and control tokens used by the translation model, and reflect the at least one of the substitution rule and the assignment rule in the translation rules and the tone control parameters updated by the processor.

### (Supplementary 3)

The system according to supplementary 1,
wherein the processor is configured to
apply an update logic that numerically adjusts at least one of the mitigation degree of aggressive expressions and the degree of politeness included in the tone control parameters in accordance with statistical values of the evaluation regarding tone appropriateness contained in the feedback information, and set the update logic on a basis of an algorithm proposal obtained from the generative artificial intelligence model.

### Application Example 2

### (Supplementary 1)

A system comprising a processor,
wherein the processor is configured to
receive, via an input unit, a message from a user in the form of an audio signal or a character string, and acquire attribute information including a speaker type, a language type, and time information associated with the message;
apply, to the audio signal, an acoustic signal processing algorithm including noise suppression, reverberation suppression, and echo cancellation to generate a processed audio signal, execute automatic speech recognition processing on the processed audio signal, and generate original-language character data;
generate, based on the original-language character data and language-type information, target-language character data by using a machine translation algorithm, refer to translation history information, and correct an output of the machine translation algorithm so as to maintain consistency of translations of domain-specific terms and frequent expressions, thereby outputting translation-result character data;
extract, from at least one of the processed audio signal and the original-language character data, acoustic feature information and linguistic feature information, and input the acoustic feature information and the linguistic feature information to an emotion classification model to estimate an emotion state of the speaker and an intensity of the emotion state;
construct, based on the translation-result character data, the estimated emotion state, and conversational context information, a prompt sentence that instructs a generative artificial intelligence model regarding output content, writing style, tone, and constraint conditions, input the prompt sentence to the generative artificial intelligence model, and obtain revised target-language character data adapted to the emotion state;
determine, based on the revised target-language character data, auditory characteristics and preference information of a recipient, and the emotion state, audio output parameters including at least a sound volume, a speaking rate, and a pitch, perform speech synthesis processing using the revised target-language character data as input, and output synthesized speech adjusted according to the audio output parameters; and
acquire, from the user, evaluation information regarding at least one of the revised target-language character data, the synthesized speech corresponding to a translation result, and the estimated emotion state, and update, based on the evaluation information and conversation history, at least one of learning data or control parameters of the machine translation algorithm, the emotion classification model, and the generative artificial intelligence model.

### (Supplementary 2)

The system according to supplementary 1,
wherein the processor is configured to
analyze the conversation history and the evaluation information accumulated by feedback processing, generate template information summarizing, for each emotion state, situation type, and language pair, recommended writing styles and expression patterns, construct a meta-level prompt sentence including the template information, input the meta-level prompt sentence to the generative artificial intelligence model to automatically generate a group of prompt sentence templates corresponding to respective emotion states and situation types, store the generated group of prompt sentence templates in a dialog strategy table, and, in subsequent construction of the prompt sentence, dynamically generate the prompt sentence by selecting or combining one or more prompt sentence templates from the dialog strategy table in accordance with the emotion state and the conversational context information.

### (Supplementary 3)

The system according to supplementary 1,
wherein the processor is configured to
statistically aggregate the evaluation information and the conversation history including the emotion state, the translation-result character data, used prompt sentence templates, and attribute information of the recipient, extract combinations of conditions that yield low evaluation according to an evaluation index, construct a retraining data set for the emotion classification model by using audio data and character data corresponding to the extracted combinations of conditions, retrain the emotion classification model based on the retraining data set, identify, in the dialog strategy table, the prompt sentence templates corresponding to the extracted combinations of conditions, cause the generative artificial intelligence model to generate revised proposals for the identified prompt sentence templates, and update the dialog strategy table based on the revised proposals.

What is claimed is:

1. A system comprising:
circuitry configured to:
receive, via a communication interface coupled to a packet-switched network, message data input by a user from a terminal device and a target language identifier;
translate the message data into the specified target language using a machine learning translation model;
perform terminology consistency processing on the translated message data based on translation history data stored in a storage device coupled to the packet-switched network;
transmit the translated message data to a recipient terminal device via the communication interface without providing the user an option to confirm the translated message data prior to transmission; and
generate a prompt data structure encoding translation performance characteristics derived from the translation history data, transmit the prompt data structure to a generative neural network model, and update at least one parameter of the machine learning translation model based on response data received from the generative neural network model.

2. The system according to claim 1, wherein the terminal device performs at least one of error correction processing, noise reduction processing, character recognition processing, and speech recognition processing on user input to generate the message data as standardized message information before transmitting the message data to the circuitry.

3. The system according to claim 2, wherein the user input includes at least one of character information input via a keyboard interface, voice information input via a microphone, and handwriting information input via a touch-sensitive surface, and wherein the terminal device converts each input type into the standardized message information in a unified text format.

4. The system according to claim 3, wherein the circuitry performs language determination processing on the standardized message information to automatically identify a source language of the message data when the source language is not explicitly specified by the user.

5. The system according to claim 4, wherein the terminal device provides an interface through which the user selects the target language identifier from a list of available languages, and wherein the circuitry stores a default target language preference associated with the user in the storage device for use when no explicit selection is made.

6. The system according to claim 1, wherein the machine learning translation model comprises a neural machine translation model with an encoder-decoder architecture, and wherein the circuitry executes the translation by encoding the message data into a latent representation and decoding the latent representation into the target language.

7. The system according to claim 6, wherein the terminology consistency processing includes comparing terminology in the translated message data against previously translated terminology stored in the translation history data, and correcting expressions in the translated message data to maintain consistent use of terms across multiple translation sessions with a same recipient.

8. The system according to claim 7, wherein the circuitry further applies context-aware post-processing to the translated message data by analyzing a conversation thread associated with the recipient to adjust formality level and idiomatic expressions based on the communication context.

9. The system according to claim 1, wherein the circuitry performs aggregation processing and analysis processing on the translation history data to generate characteristic information relating to translation performance including accuracy metrics, error frequency distributions, and domain-specific terminology usage patterns.

10. The system according to claim 9, wherein the prompt data structure includes a structured text sequence encoding the characteristic information and specific translation error examples extracted from the translation history data, and wherein the generative neural network model comprises a transformer-based architecture with a plurality of self-attention layers.

11. The system according to claim 10, wherein the response data received from the generative neural network model includes at least one of updated translation model configuration parameters, updated terminology consistency processing conditions, and updated translation parameters, and wherein the circuitry applies the updates to the machine learning translation model without interrupting ongoing translation sessions.

12. The system according to claim 1, wherein the circuitry is further configured to receive, via the communication interface, evaluation data from the terminal device indicating a quality assessment of the translated message data and improvement request data specifying corrections to the translated message data, and to store the evaluation data and the improvement request data in association with the translation history data.

13. The system according to claim 12, wherein the circuitry incorporates the improvement request data into subsequent terminology consistency processing by adding corrected expressions to a terminology dictionary stored in the storage device, and includes the evaluation data in the translation performance characteristics encoded in the prompt data structure for the generative neural network model.

14. The system according to claim 1, wherein the circuitry simultaneously translates the message data into a plurality of target languages for transmission to a plurality of recipient terminal devices in a group communication session, each recipient terminal device receiving the translated message data in a respective target language.

15. The system according to claim 14, wherein the circuitry receives response message data from at least one recipient terminal device, translates the response message data into the language of the user, and transmits the translated response message data to the terminal device, enabling bidirectional cross-lingual communication within the group communication session.

16. The system according to claim 1, wherein the circuitry is further configured to analyze sentiment and emotional tone of the message data using a natural language processing model, and to adjust the translation to preserve the detected sentiment and emotional tone in the translated message data.

17. The system according to claim 16, wherein the circuitry estimates a communication urgency level based on at least one of message frequency, message length patterns, and detected urgency keywords, and prioritizes translation processing latency for messages with higher estimated urgency levels.

18. A system comprising:
a communication interface including a network interface controller coupled to a packet-switched network and configured to transmit and receive data packets;
a memory storing instructions, a machine learning translation model comprising a neural machine translation model with an encoder-decoder architecture, a generative neural network model comprising a transformer architecture with a plurality of self-attention layers, translation history data, and a terminology dictionary; and
circuitry comprising one or more processors coupled to the memory and configured to execute the instructions to:
receive, via the communication interface, message data from a terminal device and a target language identifier;
translate the message data into the specified target language using the machine learning translation model;
perform terminology consistency processing on the translated message data by comparing terminology against the translation history data and correcting expressions to maintain consistency;
transmit the translated message data to a recipient terminal device via the communication interface without requiring user confirmation prior to transmission;
receive evaluation data and improvement request data from the terminal device and store the data in association with the translation history data;
generate characteristic information from the translation history data, construct a prompt data structure encoding the characteristic information, transmit the prompt data structure to the generative neural network model, and update parameters of the machine learning translation model based on response data from the generative neural network model.

19. The system according to claim 18, wherein the circuitry is further configured to analyze sentiment and emotional tone of the message data and to adjust the translation to preserve the detected sentiment and emotional tone in the translated message data.

20. A method performed by circuitry of a server coupled to a packet-switched network via a communication interface, the method comprising:
receiving, via the communication interface, message data input by a user from a terminal device and a target language identifier;
translating the message data into the specified target language using a machine learning translation model;
performing terminology consistency processing on the translated message data based on translation history data stored in a storage device coupled to the packet-switched network;
transmitting the translated message data to a recipient terminal device via the communication interface without providing the user an option to confirm the translated message data prior to transmission; and
generating a prompt data structure encoding translation performance characteristics derived from the translation history data, transmitting the prompt data structure to a generative neural network model, and updating at least one parameter of the machine learning translation model based on response data received from the generative neural network model.
